(19) United States
(12) Patent Application Publication
(10) Pub. No.: US 2026/0075331 A1
(43) Pub. Date: Mar. 12, 2026

(54) PHOTODETECTION ELEMENT AND ELECTRONIC DEVICE

(71) Applicant: SONY SEMICONDUCTOR SOLUTIONS CORPORATION, KANAGAWA (JP)

(72) Inventors: FUTA MOCHIZUKI, KANAGAWA (JP); ATSUMI NIWA, KANAGAWA (JP); KOHEI YAMADA, KANAGAWA (JP); YOSHITAKA NIIDA, KANAGAWA (JP); YOTARO IMAI, KANAGAWA (JP)

(21) Appl. No.: 19/108,792

(22) PCT Filed: Sep. 5, 2023
(86) PCT No.: PCT/JP2023/032306

§ 371 Date: Mar. 5, 2025

(30) Foreign Application Priority Data
Sep. 13, 2022 (JP) 2022-145419

(51) Int. Cl. H04N 25/47; H04N 25/772

(52) U.S. Cl. CPC H04N 25/47; H04N 25/772

(57) ABSTRACT

To make it possible to downsize a pixel as compared with a conventional pixel, and to perform on/off switching control for each of functions.

A photodetection element includes: a photoelectric conversion element that accumulates charges according to an amount of incident light; and a pixel circuit that outputs a pixel signal according to the charges accumulated in the photoelectric conversion element, in which the pixel circuit includes: at least one current path; and at least two current cutoff switching units that switch whether or not to cut off the current path.

### TECHNICAL FIELD

The present disclosure relates to a photodetection element and an electronic device.

### BACKGROUND ART

A photodetection element that detects incident light includes a plurality of pixels, and performs photoelectric conversion for each pixel. There is known a method of reducing power consumption by performing photoelectric conversion only in a part of the plurality of pixels in the photodetection element.

Patent Document 1 proposes a method for causing a plurality of pixels arranged in the horizontal and the vertical directions to perform photoelectric conversion operation by selecting a pixel in any rectangular region by a control signal in the horizontal direction and a control signal in the vertical direction.

### CITATION LIST

### Patent Document

Patent Document 1: Japanese Patent Application Laid-Open No. 2016-184843

### SUMMARY OF THE INVENTION

### Problems to be Solved by the Invention

Each pixel in Patent Document 1 combines the control signal in the horizontal direction and the control signal in the vertical direction by using a logic circuit such as an AND circuit. For this reason, it is necessary to dispose the logic circuit inside the pixel, and the pixel size increases. Furthermore, since selection of the pixel is switched by a signal obtained by combination of a plurality of control signals input to the pixel by the logic circuit, selection of the pixel cannot be switched for each control signal.

The present disclosure has been made in view of the above-described problems, and provides a photodetection element capable of reducing the size of the pixel and flexibly selecting the pixel to reduce the power consumption as compared with the related art.

### Solutions to Problems

In order to solve the above problem, according to the present disclosure, there is provided a photodetection element including:
a photoelectric conversion element that accumulates charges according to an amount of incident light; and
a pixel circuit that outputs a pixel signal according to the charges accumulated in the photoelectric conversion element, in which
the pixel circuit includes:
at least one current path; and
at least two current cutoff switching units that switch whether or not to cut off the current path.

The pixel circuit may include a first current path, a second current path, a first current cutoff switching unit, and a second current cutoff switching unit,
the first current cutoff switching unit may switch whether or not to cut off the first current path, and
the second current cutoff switching unit may switch whether or not to cut off the second current path.

The pixel circuit may include a first current cutoff switching unit and a second current cutoff switching unit disposed on one current path, and
the first current cutoff switching unit and the second current cutoff switching unit may switch whether or not to cut off the current path independently of each other.

There may be included: a first control unit that performs control to switch two or more of the current cutoff switching units in two or more of the pixel circuits arranged in a first direction at an identical timing; and
a second control unit that performs control to switch at an identical timing two or more of the current cutoff switching units in two or more of the pixel circuits arranged in a second direction.

There may be included a pixel array unit including a plurality of pixels arranged in the first direction and the second direction, in which
each of the plurality of pixels may include the photoelectric conversion element and the pixel circuit, and
the first control unit and the second control unit may perform control to output, from the pixel array unit, a pixel signal in a focused pixel region including one or more pixels disposed at any location in the pixel array unit by performing switching control of the current cutoff switching units included in each of the plurality of pixels.

The first control unit and the second control unit may perform control to switch a location of the focused pixel region in the pixel array unit in units of frames such that a part of the focused pixel region overlaps or does not overlap, by performing switching control of the current cutoff switching units included in each of the plurality of pixels.

Some pixels of the plurality of pixels each may output an event signal generated on the basis of an amount of change of the charges accumulated in the photoelectric conversion element corresponding to each pixel, and
the first control unit and the second control unit may set the location of the focused pixel region by performing switching control of the current cutoff switching units in the some pixels in accordance with a pixel position at which the event signal is output.

The first control unit and the second control unit may perform switching control of the current cutoff switching units in the plurality of pixels such that the focused pixel region is disposed within a range of an entire region in the first direction and a partial region in the second direction in the pixel array unit, within a range of a partial region in the first direction and an entire region in the second direction in the pixel array unit, or within a range of a partial region in the first direction and a partial region in the second direction in the pixel array unit.

There may be included a pixel array unit including a plurality of pixels arranged in the first direction and the second direction, in which
each of the plurality of pixels may include a plurality of subpixels,
each of the plurality of subpixels may include the photoelectric conversion element, the pixel circuit, the at least one current path, and the at least two current cutoff switching units, and
the plurality of subpixels in the pixels may sequentially output pixel signals for each of frames, by switching the current cutoff switching units included in each of the plurality of subpixels.

There may be included a pixel array unit including a plurality of pixels arranged in the first direction and the second direction, in which
each of the plurality of pixels may include a plurality of subpixels,
each of the plurality of subpixels may include the photoelectric conversion element, the pixel circuit, the at least one current path, and the at least two current cutoff switching units,
at least one subpixel of the plurality of subpixels in the pixels may output the pixel signal including event information generated on the basis of an amount of change of the charges accumulated in the photoelectric conversion element corresponding to the subpixel, and remaining subpixels each may output the pixel signal including grayscale information according to the charges accumulated in the photoelectric conversion element corresponding to each subpixel.

Some current cutoff switching units of the at least two current cutoff switching units may perform switching of a bias current and switching of whether or not to cut off the current path.

The pixel circuit may include an event detection circuit that detects an event generated on the basis of an amount of change of the charges accumulated in the photoelectric conversion element, and
the event detection circuit may include the at least one current path and the at least two current cutoff switching units.

The event detection circuit may include:
a current-voltage conversion unit that converts the charges accumulated in the photoelectric conversion element into a voltage;
a buffer that generates a voltage signal according to an output of the current-voltage conversion unit;
a differentiation circuit that detects an amount of change of the voltage signal;
a comparison circuit that compares the amount of change of the voltage signal with a predetermined threshold; and
an output circuit that outputs an event signal representing the event according to a comparison result by the comparison circuit.

At least two of the current-voltage conversion unit, the buffer, the differentiation circuit, the comparison circuit, or the output circuit may include the current path and the current cutoff switching units.

At least one of the current-voltage conversion unit, the buffer, the differentiation circuit, the comparison circuit, or the output circuit may include two or more of the current cutoff switching units disposed on one of the current paths.

The pixel circuit may include an analog-to-digital conversion unit that converts a voltage signal according to the charges accumulated in the photoelectric conversion element into a digital signal, and
the analog-to-digital conversion unit may include the at least one current path and the at least two current cutoff switching units.

The current cutoff switching units each may include one transistor that switches whether or not to cut off the current path.

The current cutoff switching units each may include one transistor that switches whether or not to cut off the current path, and switches whether or not to supply a bias current to the current path.

Furthermore, according to the present disclosure, there is provided an electronic device including:
a photodetection element that outputs image data; and
a processing unit that performs processing on the image data, in which
the photodetection element includes:
a photoelectric conversion element that accumulates charges according to an amount of incident light; and
a pixel circuit that outputs a pixel signal according to the charges accumulated in the photoelectric conversion element, and
the pixel circuit includes:
at least one current path; and
at least two current cutoff switching units that switch whether or not to cut off the current path.

### BRIEF DESCRIPTION OF DRAWINGS

FIG. 1 is a block diagram illustrating a configuration example of a photodetection element in a first embodiment.

FIG. 2 is a diagram illustrating an example of a chip configuration of the photodetection element.

FIG. 3 is a plan view illustrating a configuration example of a pixel chip in the first embodiment.

FIG. 4 is a block diagram in which a configuration of a pixel array unit is further embodied.

FIG. 5 is a circuit diagram illustrating an example of a circuit configuration of a pixel.

FIG. 6 is a diagram illustrating a configuration example of a pixel for EVS in the first embodiment.

FIG. 7A is a diagram illustrating a configuration example of a pixel circuit in which one current cutoff switching unit is disposed in each of two current paths.

FIG. 7B is a diagram illustrating a configuration example of a pixel circuit in which two current cutoff switching units are disposed in one current path.

FIG. 7C is a diagram illustrating a configuration example of a pixel circuit in which two PMOS transistors are disposed in one current path.

FIG. 7D is a diagram illustrating a configuration example of a pixel circuit in which two NMOS transistors are disposed in one current path.

FIG. 7E is a diagram illustrating a configuration example of a pixel circuit in which two current cutoff switching units and two circuit units are disposed in one current path.

FIG. 8 is a diagram illustrating a pixel circuit of a comparative example.

FIG. 9A is a diagram illustrating a configuration example of a pixel array unit in a modification of the first embodiment.

FIG. 9B is a diagram illustrating a configuration example of a pixel array unit in a case where an event detection circuit is shared in the modification of the first embodiment.

FIG. 10 is a block diagram illustrating a configuration example of a photodetection element in a second embodiment.

FIG. 11A is a diagram illustrating an example in which an ROI is set in a range of an entire region in the X direction and a partial region in the Y direction in the pixel array unit.

FIG. 11B is a diagram illustrating an example in which an ROI is set in a range of a partial region in the X direction and an entire region in the Y direction in the pixel array unit.

FIG. 11C is a diagram illustrating an example in which an ROI is set within a range of a partial region in the X direction and a partial region in the Y direction in the pixel array unit.

FIG. 12 is a block diagram illustrating a configuration example of a photodetection element in a third embodiment.

FIG. 13A is a diagram illustrating an example in which an ROI before switching and an ROI after switching do not overlap.

FIG. 13B is a diagram illustrating an example in which an ROI before switching and an ROI after switching partially overlap.

FIG. 14 is a diagram illustrating a switching timing of the ROI of the photodetection element.

FIG. 15 is a block diagram illustrating a configuration example of a photodetection element in a fourth embodiment.

FIG. 16 is a diagram illustrating an example of thinning control.

FIG. 17A is a diagram illustrating frame-by-frame processing of thinning operation of the photodetection element in a case where forced reset operation is sequentially performed on each of subpixels.

FIG. 17B is a diagram illustrating frame-by-frame processing of the thinning operation of the photodetection element in a case where the forced reset operation is simultaneously performed on all the subpixels.

FIG. 18 is a block diagram illustrating a configuration example of a photodetection element in a fifth embodiment.

FIG. 19 is a block diagram illustrating a configuration example of a pixel circuit in the fifth embodiment.

FIG. 20 is a block diagram illustrating an example of a schematic configuration of a vehicle control system.

FIG. 21 is an explanatory diagram illustrating an example of installation positions of an outside-vehicle information detecting section and an imaging section.

### MODE FOR CARRYING OUT THE INVENTION

Hereinafter, embodiments of a photodetection element and an electronic device will be described with reference to the drawings. Although principal components of the photodetection element and the electronic device will be mainly described below, the photodetection element and the electronic device may include components and functions that are not illustrated or described. The following description is not intended to exclude components and functions that are not illustrated or described.

### First Embodiment

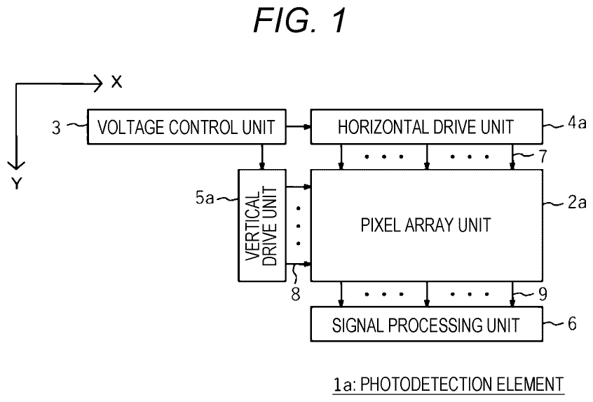

FIG. 1 is a block diagram illustrating a configuration example of a photodetection element 1a in a first embodiment of the present technology. The photodetection element 1a is used for imaging or detecting a change in light, and is, for example, an event-based vision sensor (EVS). Various devices incorporating the photodetection element 1a, for example, a camera system mounted on an industrial robot, an in-vehicle camera system, or the like constitutes an electronic device according to the present disclosure.

The photodetection element 1a of FIG. 1 includes a pixel array unit 2a, a voltage control unit 3, a horizontal drive unit (first control unit) 4a, a vertical drive unit (second control unit) 5a, and a signal processing unit 6.

The pixel array unit 2a includes a plurality of pixels two-dimensionally arranged in a matrix. In the present specification, the horizontal direction in FIG. 1 is referred to as a row direction X (first direction), and the vertical direction is referred to as a column direction Y (second direction). Each pixel includes a photoelectric conversion element and a pixel circuit. The photoelectric conversion element receives light from a subject and generates charges according to an amount of received light. The generated charges are converted into a pixel signal by the pixel circuit. The pixel signal is a voltage signal according to the charges generated by the photoelectric conversion element. An arrangement of the pixel circuit and the photoelectric conversion element in the pixel array unit 2a and a structure of the pixel will be described later.

A horizontal drive line 7 is disposed for each pixel column disposed in the column direction Y in the pixel array unit 2a. The horizontal drive unit 4a generates a plurality of horizontal drive signals for controlling whether or not to drive a plurality of pixel columns disposed in the column direction Y, and supplies the plurality of horizontal drive signals to respective pixel columns via a plurality of the horizontal drive lines 7. A vertical drive line 8 is disposed for each pixel row disposed in the row direction X in the pixel array unit 2a. The vertical drive unit 5a generates a plurality of vertical drive signals for controlling whether or not to drive a plurality of pixel rows disposed in the row direction X, and supplies the plurality of vertical drive signals to respective pixel rows via a plurality of the vertical drive lines 8.

The horizontal drive unit 4a switches logic of the plurality of horizontal drive signals at the same timing, whereas the vertical drive unit 5a can sequentially switch logic of the plurality of vertical drive signals. The horizontal drive unit 4a can select and drive a pixel block in any range in the row direction X. Furthermore, the vertical drive unit 5a can select a pixel block in any range in the column direction Y and sequentially drive pixels in the selected pixel block.

A vertical signal line 9 is disposed for each pixel column disposed in the column direction Y in the pixel array unit 2a. The vertical signal line 9 transmits a pixel signal output from each pixel in a corresponding pixel column to the signal processing unit 6. Each pixel constituting one pixel row disposed in the row direction X in the pixel array unit 2a outputs a pixel signal to a corresponding vertical signal line 9 at the same timing.

The vertical drive unit 5a performs two types of scanning, reading and sweeping, on the plurality of pixel rows. In the reading, each pixel in the selected pixel row transmits an analog pixel signal according to the amount of received light to the signal processing unit 6 via the corresponding vertical signal line 9. In the sweeping, each pixel in the selected pixel row performs reset processing for sweeping unnecessary charges from the pixel circuit and newly starting exposure.

The signal processing unit 6 performs signal processing on the pixel signal output from each pixel. Specifically, analog to digital (AD) conversion, black level correction, and the like are performed as necessary, and image data is generated in units of frames. The signal processing unit 6 outputs the image data to a device at the subsequent stage.

The voltage control unit 3 controls voltage levels of the plurality of horizontal drive signals output from the horizontal drive unit 4a and the plurality of vertical drive signals output from the vertical drive unit 5a.

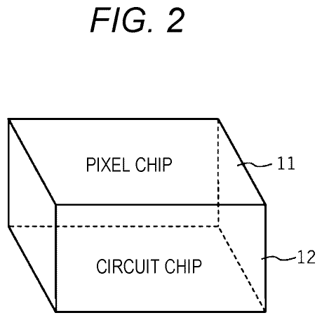

The photodetection element 1a of FIG. 1 can include a semiconductor chip having a stacked structure. FIG. 2 is a diagram illustrating an example of a chip configuration of the photodetection element 1a. The photodetection element 1a of FIG. 2 has a stacked structure in which a pixel chip 11 and a circuit chip 12 are stacked. These chips are connected together by Cu—Cu bonding or the like to perform transmission of various signals. Note that the pixel chip 11 and the circuit chip 12 may be connected together by a via, a bump, or the like in addition to Cu—Cu bonding.

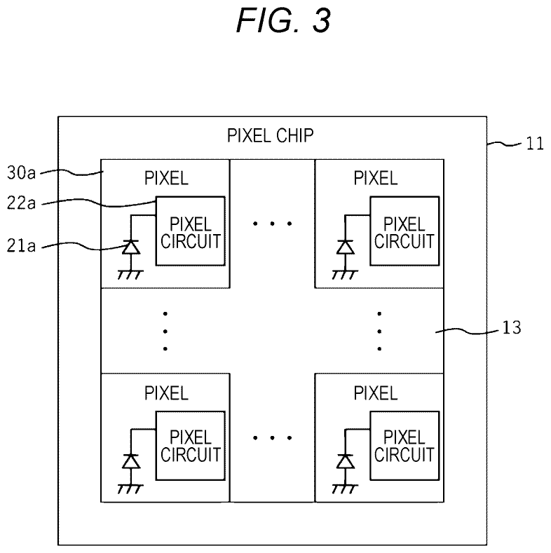

FIG. 3 is a plan view illustrating a configuration example of the pixel chip 11. The pixel chip 11 is provided with a light receiving unit 13. The light receiving unit 13 includes a plurality of pixels 30a arranged in a two-dimensional direction. Each pixel 30a includes a photoelectric conversion element 21a and at least a part of a pixel circuit 22a. More specifically, in the pixel chip 11, there are a case where the entire pixel circuit 22a of each pixel circuit 30a is disposed and a case where a part of the pixel circuit 22a is disposed. As described above, each pixel circuit 22a may be disposed only on the pixel chip 11, or may be disposed in a distributed manner on the pixel chip 11 and the circuit chip 12. Furthermore, in the circuit chip 12, the horizontal drive unit 4a, the vertical drive unit 5a, and the signal processing unit 6 of FIG. 1 are disposed.

Typically, one pixel 30a includes one pixel circuit 22a and one photoelectric conversion element 21a, but in some cases, one pixel 30a may include a plurality of photoelectric conversion elements 21a. Furthermore, one pixel 30a may include a plurality of subpixels including one pixel circuit 22a and at least one photoelectric conversion element 21a. The subpixels will be described later.

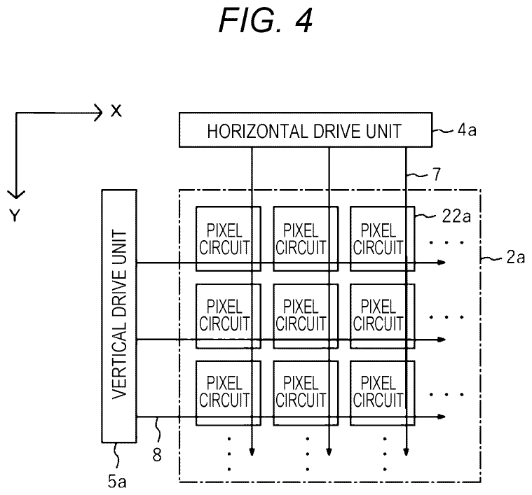

FIG. 4 is a block diagram in which a configuration of the pixel array unit 2a of FIG. 1 is further embodied. In FIG. 4, the signal processing unit 6 and the vertical signal line 9 of FIG. 1 are omitted. The pixel array unit 2a includes a plurality of pixels 30a disposed in each of the row direction X and the column direction Y. In the pixel array unit 2a, the plurality of horizontal drive lines 7 extending from the horizontal drive unit 4a in the column direction Y and the plurality of vertical drive lines 8 extending from the vertical drive unit 5a in the row direction X are disposed. The horizontal drive lines 7 and the vertical drive lines 8 are connected to the pixel circuit 22a.

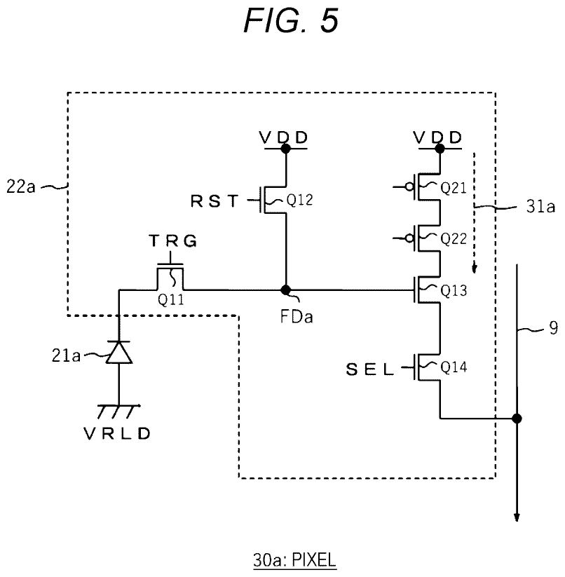

FIG. 5 is a circuit diagram illustrating an example of a circuit configuration of the pixel 30a. The pixel 30a of FIG. 5 includes the photoelectric conversion element 21a and the pixel circuit 22a.

The photoelectric conversion element 21a accumulates charges (hereinafter, photocharges) according to the amount of incident light to a corresponding pixel 30a. The photoelectric conversion element 21a is a photodiode, for example.

The pixel circuit 22a outputs a pixel signal according to the photocharges accumulated in the photoelectric conversion element 21a. The pixel circuit 22a includes a transfer transistor Q11, a reset transistor Q12, an amplification transistor Q13, a selection transistor Q14, and a current path 31a. The transfer transistor Q11, the reset transistor Q12, and the amplification transistor Q13 are connected to a floating diffusion (floating diffusion region/impurity diffusion region) FDa. The pixel signal output from the pixel 30a is input to the above-described signal processing unit 6 via the vertical signal line 9.

In the present specification, an example will be described in which four transistors in the pixel circuit 22a, which are the transfer transistor Q11, the reset transistor Q12, the amplification transistor Q13, and the selection transistor Q14, are, for example, N channel Metal-Oxide-Semiconductor (NMOS) transistors. However, any conductivity type can be used for the four transistors exemplified here.

FIG. 5 illustrates an example of the pixel circuit 22a having a 4-Tr configuration including four transistors (Trs) except for transistors Q21 and Q22 on the current path 31a. The number of transistors constituting the pixel circuit is not limited to four. For example, a 3-Tr configuration may be employed in which the selection transistor Q14 is omitted and the amplification transistor Q13 has a function of the selection transistor Q14, or a configuration of 5-Tr or more may be employed in which the number of transistors is increased, as necessary.

The selection transistor Q14 is used for scanning control of the pixel 30a. For example, a vertical drive signal from the vertical drive unit 5a is applied to the gate of the selection transistor Q14. As a result, the plurality of pixel rows arranged in the column direction Y is driven by a corresponding vertical drive signal for each pixel row.

In the photoelectric conversion element 21a, one of the cathode and the anode is connected to the transfer transistor Q11, and the other is connected to a reference voltage node VRLD such as ground. Hereinafter, in the present specification, an example will be described in which the cathode is connected to the transfer transistor Q11.

The transfer transistor Q11 is used for switching transfer of the photocharges. In the transfer transistor Q11, the source is connected to the photoelectric conversion element 21a, and the drain is connected to the floating diffusion FDa. The transfer transistor Q11 is turned on by application of a transfer signal TRG at a high level (for example, a high-potential side power supply VDD level to be described later) to the gate. As a result, the photocharges accumulated in the photoelectric conversion element 21a are transferred to the floating diffusion FDa.

The reset transistor Q12 is used for resetting an amount of photocharges in the pixel 30a. In the reset transistor Q12, the source is connected to the floating diffusion FDa, and the drain is connected to a node of the high-potential side power supply VDD. The reset transistor Q12 is turned on by application of a reset signal RST at the high level to the gate. As a result, the charges of the floating diffusion FDa are discharged to the node of the high-potential side power supply VDD, whereby the floating diffusion FDa is reset.

The floating diffusion FDa accumulates the photocharges transferred from the photoelectric conversion element 21a. As a result, the floating diffusion FDa has a potential according to the accumulated charges.

The gate of the amplification transistor Q13 has the same potential as the floating diffusion FDa, and is used as an input part of the source follower circuit. The drain of the amplification transistor Q13 is connected to the node of the high-potential side power supply VDD via the current path 31a, and the source is connected to the selection transistor Q14. A source voltage of the amplification transistor Q13 changes according to the potential of the floating diffusion FDa. The source of the amplification transistor Q13 is connected to the drain of the selection transistor Q14. The selection transistor Q14 is turned on when a selection signal SEL applied to the gate thereof is at the high level, and a pixel signal of a voltage level according to the potential of the floating diffusion FDa is transmitted from the source of the selection transistor Q14 to the vertical signal line 9.

In the current path 31a in the pixel 30a illustrated in FIG. 5, at least two current cutoff switching units are disposed that switch whether or not to cut off the current path 31a. Specifically, the transistor Q21 and the transistor Q22 are connected to the current path 31a as two current cutoff switching units. FIG. 5 illustrates an example in which both of the two current cutoff switching units are PMOS transistors, but any conductivity type can be used for the transistors. The transistor Q21 and the transistor Q22 are cascode-connected, the transistor Q21 is connected to the node of the high-potential side power supply VDD, and the transistor Q22 is connected to the drain of the amplification transistor Q13.

The transistor Q21 is connected to the horizontal drive unit 4a via the horizontal drive line 7. When the horizontal drive line 7 sets the horizontal drive signal to the high level, the transistor Q21 cuts off the current path 31a. Furthermore, the transistor Q22 is connected to the vertical drive unit 5a via the vertical drive line 8. When the vertical drive line 8 sets the vertical drive signal to the high level, the transistor Q22 cuts off the current path 31a. In a case where the current path 31a is cut off by at least one of the transistor Q21 or the transistor Q22, current supply from the high-potential side power supply VDD to the amplification transistor Q13 is cut off. As a result, the amplification transistor Q13 does not transmit the voltage signal generated by the photoelectric conversion to the vertical signal line 9, and the pixel signal is not output from the pixel 30a. Note that the connection order of the transistor Q21 and the transistor Q22 may be reversed from that in FIG. 5, and the transistor Q21 may be connected to the drain of the amplification transistor Q13 and the transistor Q22 may be connected to the node of the high-potential-side power supply VDD.

As described above, the pixel circuit 22a of FIG. 5 includes at least one current path 31a and at least two current cutoff switching units Q21 and Q22 that switch whether or not to cut off the current path 31a. As a result, the pixel circuit 22a of FIG. 5 can switch the presence or absence of the output of the pixel signal by the horizontal drive signal and switch the presence or absence of the output of the pixel signal by the vertical drive signal.

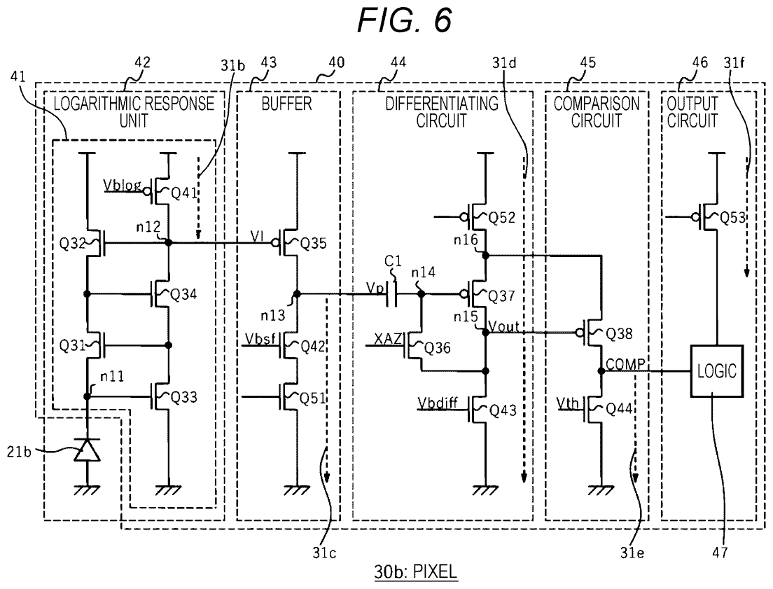

Although FIG. 5 illustrates an example in which the current cutoff switching unit is provided in the normal pixel (also referred to as a grayscale pixel) 30a, a configuration is also conceivable in which the current cutoff switching unit is provided on a current path in a pixel for an EVS (hereinafter, an EVS pixel). FIG. 6 is a diagram illustrating a configuration example of a pixel 30b in the first embodiment. The pixel 30b of FIG. 6 includes a photoelectric conversion element 21b and a pixel circuit. The pixel circuit in the pixel 30b includes an event detection circuit 40 that detects an event generated on the basis of an amount of change of charges accumulated in the photoelectric conversion element 21b.

The event detection circuit 40 in the pixel 30b includes a current-voltage conversion unit 41, a buffer 43, a differentiation circuit 44, a comparison circuit 45, and an output circuit 46. Furthermore, the event detection circuit 40 includes at least one current path and at least two current cutoff switching units.

The photoelectric conversion element 21b and the current-voltage conversion unit 41 constitute a logarithmic response unit 42. The logarithmic response unit 42 performs logarithmic conversion of the charges subjected to photoelectric conversion by the photoelectric conversion element 21b to generate a voltage signal VI. A reason for the logarithmic conversion is to widen a dynamic range of the pixel 30b for acquiring luminance information.

The photoelectric conversion element 21b is, for example, a photodiode, similarly to the photoelectric conversion element in FIG. 5. The cathode of the photoelectric conversion element 21b is connected to an input node n11 of the current-voltage conversion unit 41, and the anode is connected to a predetermined reference voltage node such as a ground voltage.

The current-voltage conversion unit 41 converts the charges accumulated in the photoelectric conversion element 21b into a voltage. The current-voltage conversion unit 41 includes transistors Q31 to Q34, and Q41. Furthermore, the current-voltage conversion unit 41 includes a current path 31b. The transistors Q31 to Q34 are, for example, NMOS transistors, and the transistor Q41 is, for example, a PMOS transistor. The transistor Q41 constitutes a current cutoff switching unit in the current path 31b.

The transistor Q31 and the transistor Q32 are cascode-connected between a power supply voltage node and the predetermined photoelectric conversion element 21b. The source of the transistor Q31 is connected to the cathode of the photoelectric conversion element 21b and the gate of the transistor Q33, and the gate is connected to the drain of the transistor Q33 and the source of the transistor Q34. The drain of the transistor Q32 is connected to the power supply voltage node, and the gate is connected to an output node n12 of the current-voltage conversion unit 41, the drain of the transistor Q34, the drain of the transistor Q41, and an input node of the buffer 43.

The transistor Q33 and the transistor Q34 are cascode-connected between the node n12 and the reference voltage (ground) node. The source of the transistor Q33 is connected to the reference voltage (ground) node, and the gate is connected to the source of the transistor Q31 and the cathode of the photoelectric conversion element 21b. The transistor Q34 is disposed between the transistor Q33 and the transistor Q41, the gate of the transistor Q34 is connected to the drain of the transistor Q31 and the source of the transistor Q32, and the drain of the transistor Q34 is connected to the output node n12.

In the current path 31b, the transistor Q41, the output node n12, the transistor Q34, and the transistor Q33 are disposed. The transistor Q41 performs switching of whether or not to cut off the current path 31b and control of a bias current flowing through the current path 31b. Specifically, the source of the transistor Q41 is connected to the power supply voltage node, and a bias voltage Vblog from the vertical drive unit 5a is applied to the gate. The transistor Q41 adjusts a voltage level to be supplied from the power supply voltage node to the output node n12 according to a signal level of the bias voltage Vblog. Furthermore, when the signal level of the bias voltage Vblog exceeds a predetermined threshold, the transistor Q41 cuts off the current path 31b and stops voltage supply from the power supply voltage node to the output node n12. As described above, by controlling the voltage level of the bias voltage Vblog, it is possible to control the bias current flowing through the current path 31b, and switch whether or not to cut off the current path 31b.

The voltage signal VI obtained by logarithmic conversion by the current-voltage conversion unit 41 is input to the buffer 43. The buffer 43 includes a transistor Q35, a transistor Q42, and a transistor Q51 cascode-connected between the power supply voltage node and the reference voltage node. Furthermore, the buffer 43 includes a current path 31c. The transistor Q35 is, for example, a PMOS transistor. The transistor Q42 and the transistor Q51 are, for example, NMOS transistors. The transistor Q42 and the transistor Q51 constitute two current cutoff switching units in the current path 31c, respectively.

The buffer 43 constitutes a source follower circuit, and outputs a pixel voltage Vp according to the voltage signal VI output from the current-voltage conversion unit 41. The voltage signal VI is input to the gate of the transistor Q35 from the output node n12 of the current-voltage conversion unit 41. The source of the transistor Q35 is connected to the power supply voltage node, and the drain is connected to the drain of the transistor Q42 and an input node of the differentiation circuit 44 via an output node n13 of the buffer 43.

In the current path 31c, the transistor Q42, the transistor Q51, and the output node n13 are disposed. The transistor Q42 performs switching of whether or not to cut off the current path 31c and control of a bias current flowing through the current path 31c. Specifically, the transistor Q42 is disposed between the output node n13 and the transistor Q51, and a bias voltage Vbsf is applied to the gate from the vertical drive unit 5a. The transistor Q42 controls the bias current flowing through the current path 31c according to a voltage level of the bias voltage Vbsf, and switches whether or not to cut off the current path 31c.

The transistor Q51 performs switching of whether or not to cut off the current path 31c. Specifically, the source of the transistor Q51 is connected to the reference voltage node, and the gate is connected to the horizontal drive line from the horizontal drive unit 4a. When the horizontal drive signal at a low level is input to the gate, the transistor Q51 cuts off the current path 31c. When at least one of the transistor Q42 or the transistor Q51 is turned off, the current path 31c is cut off, and an output signal of the logarithmic response unit 42 is not transmitted to the differentiation circuit 44. Furthermore, when both the transistor Q42 and the transistor Q51 are turned on, the bias current flows through the current path 31c, so that the buffer 43 outputs a signal (pixel voltage Vp) obtained by inversion of the output signal of the logarithmic response unit 42.

The pixel voltage Vp output from the buffer 43 is input to the differentiation circuit 44. The buffer 43 can improve the driving force of the pixel voltage Vp. Furthermore, by providing the buffer 43, it is possible to secure isolation that prevents noise generated when the differentiation circuit 44 at the subsequent stage performs switching operation from being transmitted to the current-voltage conversion unit 41.

The differentiation circuit 44 detects an amount of change of the pixel voltage Vp by differential operation. The differentiation circuit 44 includes a capacitor C1 and a transistor Q36. Furthermore, the differentiation circuit 44 includes a current path 31d. The current path 31d includes a transistor Q52, a transistor Q37, and a transistor Q43 cascode-connected between the power supply voltage node and the reference voltage node. The transistors Q36 and Q43 are, for example, NMOS transistors, and the transistors Q37 and Q52 are, for example, PMOS transistors. The transistor Q43 and the transistor Q52 constitute two current cutoff switching units in the current path 31d, respectively.

The capacitor C1 is connected between a connection node n14 of the drain of the transistor Q36 and the gate of the transistor Q37 and the output node n13 of the buffer 43. The capacitor C1 supplies a current according to an amount of change obtained by time differentiation of the pixel voltage Vp output from the buffer 43 to the drain of the transistor Q36 and the gate of the transistor Q37.

The transistor Q36 switches whether or not to short-circuit the gate and the drain of the transistor Q37 in accordance with an auto-zero signal XAZ. The auto-zero signal XAZ is a signal for giving an initialization instruction, and for example, transitions from the low level to the high level each time an event signal to be described later is output from the pixel 30b. When the auto-zero signal XAZ enters the high level, the transistor Q36 shifts to the on state, a differential signal Vout is set to an initial value, and charges of the capacitor C1 are initialized.

The transistor Q52 and a connection node n16 are disposed on the power supply voltage node side of the current path 31d. The connection node n16 is connected to the source of the transistor Q37 and is connected to the comparison circuit 45. That is, the transistor Q52 and the connection node n16 supply a power supply voltage to the source of the transistor Q37 and the comparison circuit 45. The transistor Q52 performs switching of whether or not to cut off the current path 31d. Specifically, the source of the transistor Q52 is disposed at the power supply voltage node, and the gate is connected to the horizontal drive unit 4a. When a signal at the high level is input to the gate, the transistor Q52 cuts off the current path 31d. As a result, the transistor Q52 stops voltage supply from the power supply voltage node to the transistor Q37 and the comparison circuit 45.

The transistor Q43 and an output node n15 of the differentiation circuit 44 are disposed on the reference voltage node side of the current path 31d. The transistor Q43 performs switching of whether or not to cut off the current path 31d and control of a bias current flowing through the current path 31d. Specifically, the source of the transistor Q43 is connected to the reference voltage node, and a bias voltage Vbdiff from the vertical drive unit 5a is applied to the gate. The transistor Q43 switches whether or not to cut off the current path 31d according to a signal level of the bias voltage Vbdiff, and controls the bias current flowing through the current path 31d.

The transistor Q37 and the transistor Q43 function as an inversion circuit with the connection node n14 on the gate side of the transistor Q37 as an input node and the connection node n15 of the transistor Q37 and the transistor Q43 as an output node.

The amount of change of the pixel voltage Vp indicates an amount of change in the amount of incident light of the pixel 30b. The differentiation circuit 44 supplies the differential signal Vout indicating the amount of change in the amount of incident light to the comparison circuit 45 via the output node n15.

The comparison circuit 45 compares the differential signal Vout with a constant threshold voltage. The comparison circuit 45 includes a transistor Q38 and a transistor Q44. Furthermore, the comparison circuit 45 includes a current path 31e. As the transistor Q38, for example, a PMOS transistor is used. As the transistor Q44, for example, an NMOS transistor is used. The transistor Q44 constitutes a current cutoff switching unit in the current path 31e.

The transistor Q38 and the transistor Q44 are cascode-connected between the connection node n16 and the reference voltage node. The output signal Vout of the differentiation circuit 44 is applied to the gate of the transistor Q38. A threshold voltage Vth is applied from the vertical drive unit 5a to the gate of the transistor Q44. The transistor Q38 is turned on when the output signal Vout of the differentiation circuit 44 is lower than the threshold voltage Vth, and an event signal COMP output from the drain of the transistor Q38 has the high level. The event signal COMP is input to the output circuit 46 via an output node n17.

A voltage level of the output signal Vout of the differentiation circuit 44 decreases as a degree of increase in the amount of change in the amount of light incident on the pixel 30b increases. In a case where the degree of increase in the amount of change in the amount of light incident on the pixel 30b is not so large (in a case where no event is detected), the voltage level of the output signal Vout of the differentiation circuit 44 is higher than the threshold voltage Vth, and thus, the transistor Q38 is turned off, and the event detection signal COMP has the low level. When the degree of increase in the amount of change in the amount of light incident on the pixel 30b increases, the voltage level of the output signal Vout of the differentiation circuit 44 becomes equal to or lower than the threshold voltage Vth, the transistor Q38 is turned on, and the event detection signal COMP has the high level.

The source of the transistor Q38 is connected to the power supply voltage node via the connection node n16 and the transistor Q52. When the transistor Q52 cuts off the current path 31d, a source voltage of the transistor Q38 of the comparison circuit 45 becomes unstable, and the comparison circuit 45 stops comparison operation.

A drain voltage of the transistor Q44 can be adjusted by control of a voltage level of the threshold voltage Vth, and it is possible to stop the comparison operation using the transistor Q44 by turning off the transistor Q44 to cut off a current path between the drain and the source of the transistor Q38.

The output circuit 46 of FIG. 6 outputs the event signal COMP according to a comparison result by the comparison circuit 45. The output circuit 46 includes a latch unit 47 and a transistor Q53. Furthermore, the output circuit 46 includes a current path 31f. The event signal COMP input from the comparison circuit 45 is written to the latch unit 47 as data. The data written in the latch unit 47 is read from a read circuit (not illustrated).

The transistor Q53 performs switching of whether or not to cut off the current path 31f. Specifically, the source of the transistor Q53 is disposed at the power supply voltage node, and the gate is connected to the horizontal drive unit 4a. When a signal at the high level is input to the gate, the transistor Q53 cuts off the current path 31f. As a result, the transistor Q53 stops voltage supply from the power supply voltage node to the latch unit 47.

As illustrated in FIG. 6, the pixel 30b constituting the EVS pixel includes a plurality of circuits respectively having different functions. The current paths 31b to 31f of the respective circuits have one or a plurality of current cutoff switching units. As a result, the pixel 30b can switch whether or not to cut off a current for each function. For example, in a case where a region of interest (ROI) to be described later is set, an application is possible in which the logarithmic response unit 42 that takes time for excitation is kept in the on state regardless of the ROI, and the differentiation circuit 44 and the like reduce power consumption by switching the on and off states depending on the ROI.

In the example in FIG. 6, the pixel includes the transistors Q51 to Q53 that perform switching of whether or not to cut off the current path, and the transistors Q41 to Q44 that perform switching of whether or not to cut off the current path and also perform switching of the bias voltage, but the present embodiment is not limited thereto. For example, any of the transistors Q51 to Q53 may be removed, or a current path cutoff function may be removed from any of the transistors Q41 to Q44. Alternatively, a current cutoff switching unit may be added to any current path.

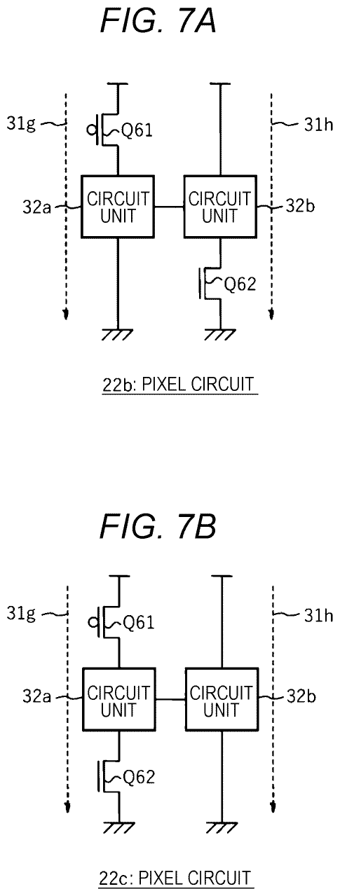

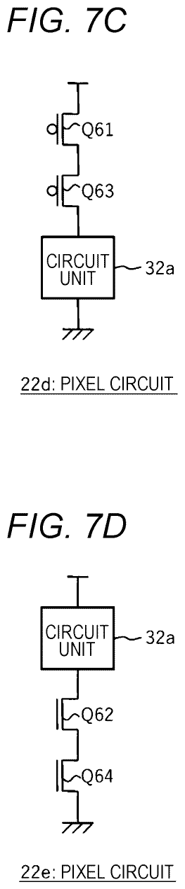

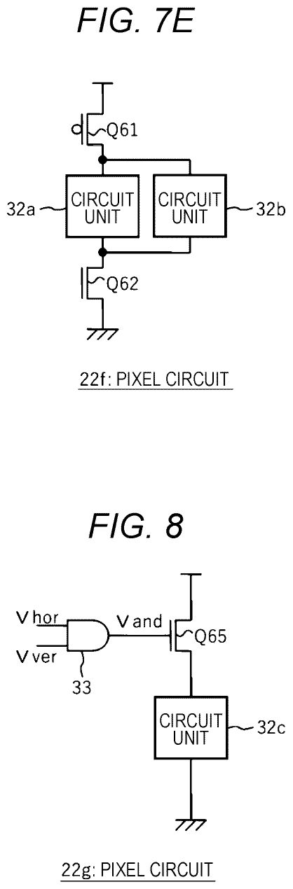

Various specific circuit forms are conceivable for a configuration in which the current cutoff switching unit is disposed in the pixel circuit having one or a plurality of current paths. FIGS. 7A to 7E are diagrams each illustrating a configuration example in which the current cutoff switching unit is disposed in the pixel circuit.

A pixel circuit 22b illustrated in FIG. 7A includes a first current path 31g connected to a circuit unit 32a and a second current path 31h connected to a circuit unit 32b. In the first current path 31g, a transistor Q61 is disposed that switches whether or not to cause a current to flow to the circuit unit 32a. In the second current path 31h, a transistor Q62 is disposed that switches whether or not to cause a current to flow to the circuit unit 32b. The transistor Q61 is, for example, a PMOS transistor, and constitutes a first current cutoff switching unit. The transistor Q62 is, for example, an NMOS transistor, and constitutes a second current cutoff switching unit. Note that it is possible to use any number of transistors disposed in the first current path 31g and the second current path 31h, any connection form of the transistors, and any conductivity type of the transistors.

The first current cutoff switching unit switches whether or not to cut off the first current path 31g. For example, the gate of the transistor Q61 is connected to the vertical drive line 8 from the vertical drive unit 5a, the source is connected to the power supply voltage node, and the drain is connected to the circuit unit 32a. In a case where a voltage at the high level is applied to the gate of the transistor Q61, the first current path 31g is cut off, and supply of the power supply voltage to the circuit unit 32a is stopped.

The second current cutoff switching unit switches whether or not to cut off the second current path 31h. For example, the gate of the transistor Q62 is connected to the horizontal drive line 7 from the horizontal drive unit 4a, the source is connected to the reference voltage node, and the drain is connected to the circuit unit 32b. In a case where a voltage at the high level is applied to the gate of the transistor Q62, the second current path 31h is not cut off. As a result, a voltage of the circuit unit 32b is set to a reference voltage level. Furthermore, in a case where a voltage at the low level is applied to the gate of the transistor Q62, the second current path 31h is cut off, and output of the circuit unit 32b is stopped.

That is, in the pixel circuit 22b illustrated in FIG. 7A, the horizontal drive unit 4a can control drive of the circuit unit 32a, and the vertical drive unit 5a can control drive of the circuit unit 32b.

In a case where the circuit form of FIG. 7A is applied to the EVS, it is only required to connect the transistors Q61 and Q62 of FIG. 7A to at least two of the current-voltage conversion unit 41, the buffer 43, the differentiation circuit 44, the comparison circuit 45, or the output circuit 46. At that time, as illustrated in FIG. 6, one current cutoff switching unit of the two current cutoff switching units may perform switching of the bias current and switching of whether or not to cut off the current path.

A pixel circuit 22c illustrated in FIG. 7B is different from that in FIG. 7A in that two current cutoff switching units are disposed in one current path. Specifically, in the pixel circuit 22c, the first current cutoff switching unit including the transistor Q61 and the second current cutoff switching unit including the transistor Q62 are disposed in the first current path 31g that causes the current to flow to the circuit unit 32a. The gate of the transistor Q62 of FIG. 7B is connected to, for example, the horizontal drive line 7 from the horizontal drive unit 4a, the source is connected to the reference voltage node, and the drain is connected to the circuit unit 32a.

In the pixel circuit 22c of FIG. 7B, the first current cutoff switching unit (transistor Q61) and the second current cutoff switching unit (transistor Q62) may be enabled to switch whether or not to cut off the first current path 31g independently of each other. Specifically, the transistor Q61 may cut off the first current path 31g under control of the horizontal drive unit 4a, and the transistor Q62 may cut off the first current path 31g under control of the vertical drive unit 5a. That is, the pixel circuit 22c illustrated in FIG. 7B can control the drive of the circuit unit 32a by the horizontal drive unit 4a and the vertical drive unit 5a.

In a case where the example in FIG. 7B is applied to the EVS, it is only required to connect the transistors Q61 and Q62 of FIG. 7B to at least one of the current-voltage conversion unit 41, the buffer 43, the differentiation circuit 44, the comparison circuit 45, or the output circuit 46.

The two current cutoff switching units illustrated in FIG. 7B may include two PMOS transistors as in a pixel circuit 22d illustrated in FIG. 7C. The first current cutoff switching unit in FIG. 7C includes the PMOS transistor Q61, the second current cutoff switching unit includes a PMOS transistor Q63, and both the transistors Q61 and Q63 are disposed on the power supply voltage node side.

The two current cutoff switching units may include two NMOS transistors as in a pixel circuit 22e illustrated in FIG. 7D. The first current cutoff switching unit in FIG. 7D includes an NMOS transistor Q64, the second current cutoff switching unit includes the PMOS transistor Q62, and both the transistors Q62 and Q64 are disposed on the reference voltage node side.

FIG. 7E is a diagram illustrating an example in which the first current cutoff switching unit and the second power cutoff switching unit are connected to two circuit units 32a and 32b connected together in parallel in a pixel circuit 22f. In FIG. 7E, the drain of the transistor Q61 in the first power cutoff switching unit is connected to the circuit units 32a and 32b, and the drain of transistor Q62 in the second power cutoff switching unit is connected to the circuit units 32a and 32b. In the pixel circuit 22f of FIG. 7E, the circuit units 32a and 32b can be controlled simultaneously and individually by the transistor Q61 controlled to be turned on/off by the horizontal drive signal from the horizontal drive unit 4a and the transistor Q62 controlled to be turned on/off by the vertical drive signal from the vertical drive unit 5a.

FIG. 8 is a diagram illustrating a pixel circuit 22g of a comparative example. The pixel circuit 22g in FIG. 8 includes a circuit unit 32c, a transistor Q65, and an AND circuit 33. The transistor Q65 is an NMOS transistor, and is used for control of voltage supply to the circuit unit 32c. In the transistor Q65, the source is connected to the circuit unit 32c, the drain is connected to the power supply voltage node, and the gate is connected to the AND circuit 33. The AND circuit 33 is connected to a horizontal drive unit and a vertical drive unit (not illustrated), and each of a signal Vhor from the horizontal drive unit and a signal Vver from the vertical drive unit is input. The AND circuit 33 performs an AND operation of the signal Vhor and the signal Vver, and inputs a result of the operation to the transistor Q65 as a signal Vand. That is, in a case where either the signal Vhor or the signal Vver is at the low level, the transistor Q65 cuts off the voltage supply to the circuit unit 32c.

The pixel circuit 22g in FIG. 8 is provided with the AND circuit 33 in order to perform both horizontal drive and vertical drive. Since the AND circuit 33 is required for each pixel, there is a problem that a circuit size increases. Furthermore, since the signals Vhor and Vver input to the pixel circuit 22g are combined by the AND circuit 33, even if the circuit unit 32c has a plurality of functions, it is not possible to switch on and off for each function.

In contrast with the pixel circuit 22g in FIG. 8, the pixel circuit 22c in FIG. 7B can perform both horizontal drive and vertical drive by the two transistors Q61 and Q62, and thus the AND circuit 33 is unnecessary. As a result, the circuit size can be reduced as compared with the pixel circuit 22g. Furthermore, it is also possible to control a plurality of circuit units respectively having different functions, such as the pixel circuit 22b in FIG. 7A, independently of each other.

As described above, in the first embodiment, by providing at least one current path and at least two current cutoff switching units that switch whether or not to cut off the current path in the pixel circuit, it is possible to select and drive any pixel among the plurality of pixels arranged in the two-dimensional direction. Since the current cutoff switching unit according to the present embodiment can be configured by one transistor, the circuit size can be reduced. Furthermore, even in a case where the pixel circuit has a plurality of functions like the EVS pixel, it is possible to perform switching control between on and off for each function. Moreover, since the horizontal drive unit 4a and the vertical drive unit 5a can select pixels to be driven independently of each other, it is possible to select a pixel at any pixel position and perform photodetection, and to reduce power consumption.

### (Modification of First Embodiment)

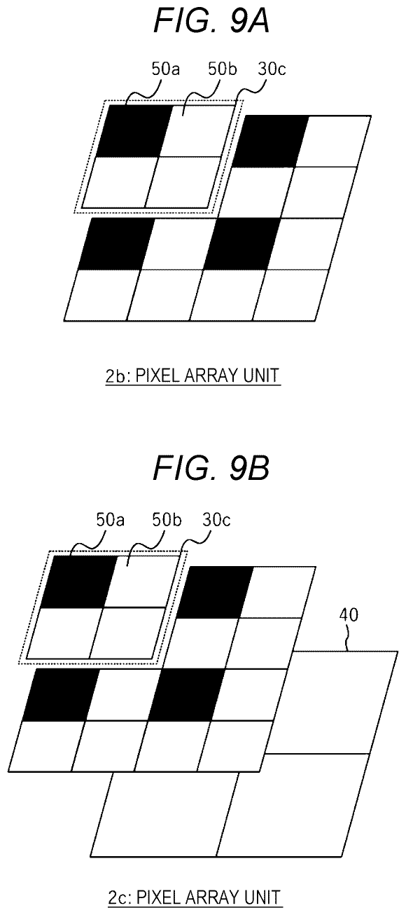

The pixel array unit 2a of the photodetection element 1a may have a configuration in which EVS pixels and grayscale pixels are disposed in combination. FIG. 9A is a diagram illustrating a pixel array unit 2b having an EVS-gradation hybrid configuration. Each of pixels 30c in the pixel array unit 2b of FIG. 9A has four subpixels. One of the four subpixels is an EVS pixel 50a, and three are grayscale pixels 50b. Each of the four subpixels includes a photoelectric conversion element separately. Furthermore, each of the four subpixels may have a pixel circuit separately. For example, the EVS pixel 50a may include the event detection circuit 40 illustrated in FIG. 6, and the grayscale pixel 50b may include the pixel circuit 22a illustrated in FIG. 5. In this case, the EVS pixel 50a outputs a pixel signal including event information generated on the basis of an amount of change of the charges accumulated in the photoelectric conversion element. Furthermore, the grayscale pixel 50b outputs a pixel signal including grayscale information corresponding to the charges accumulated in the photoelectric conversion element.

Alternatively, any one of the four subpixels may be used as the EVS pixel 50a, and remaining three may be used as the grayscale pixels 50b. In this case, the subpixels used as the EVS pixels 50a may be sequentially switched. A pixel array unit 2c illustrated in FIG. 9B includes the event detection circuit 40 for each pixel 30c in association with the pixel 30c including four subpixels. Each of the four subpixels separately includes the photoelectric conversion element, the pixel circuit 22a, and the selection circuit (not illustrated). The selection circuit switches whether each photoelectric conversion element is connected to the event detection circuit 40 or the pixel circuit 22a. In a case where the photoelectric conversion element is connected to the event detection circuit 40, the photoelectric conversion element constitutes the EVS pixel 50a. Furthermore, in a case where the photoelectric conversion element is connected to the pixel circuit 22a, the photoelectric conversion element constitutes the grayscale pixel 50b.

### Second Embodiment

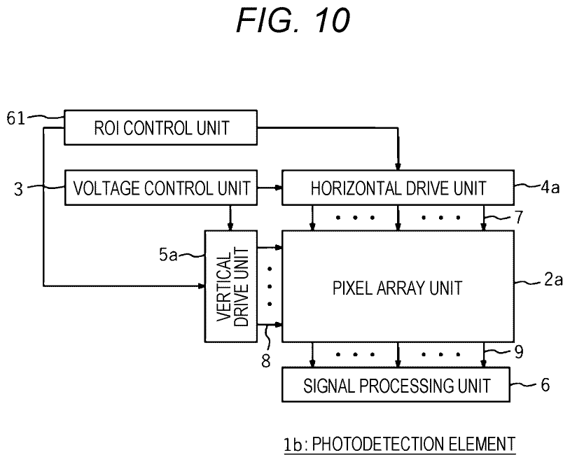

The horizontal drive and the vertical drive according to the first embodiment can be applied to setting of a focused pixel region (ROI; Region of Interest). FIG. 10 is a block diagram illustrating a configuration example of a photodetection element 1b in a second embodiment. The photodetection element 1b in FIG. 10 includes an ROI control unit 61 that performs control of the horizontal drive unit 4a and the vertical drive unit 5a.

The horizontal drive unit 4a and the vertical drive unit 5a in the photodetection element 1b are controlled by the ROI control unit 61, and perform switching control of the current cutoff switching unit included in each of the plurality of pixels 30b. As a result, the horizontal drive unit 4a and the vertical drive unit 5a perform control to output a pixel signal in the ROI including one or more pixels 30b disposed at any location in the pixel array unit 2a from the pixel array unit 2a.

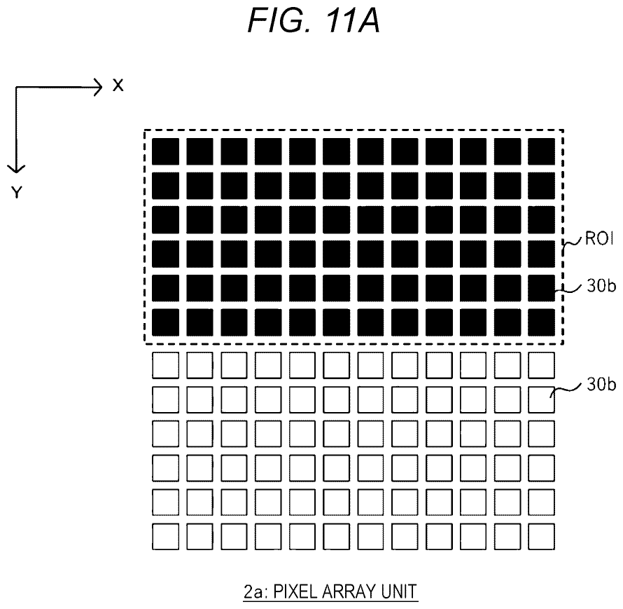

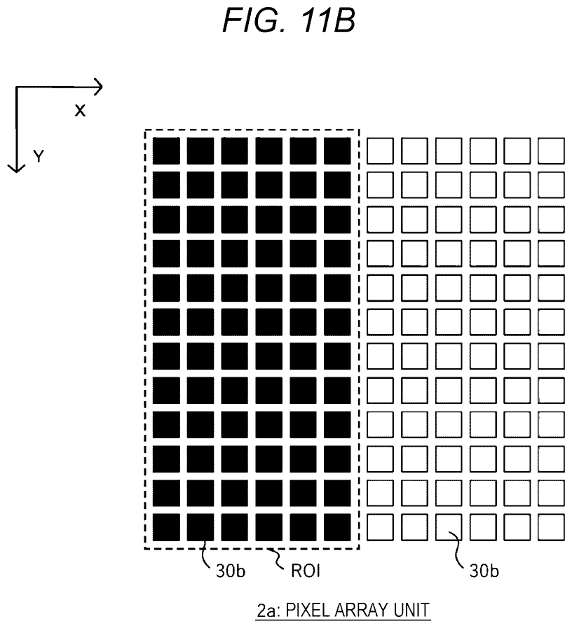

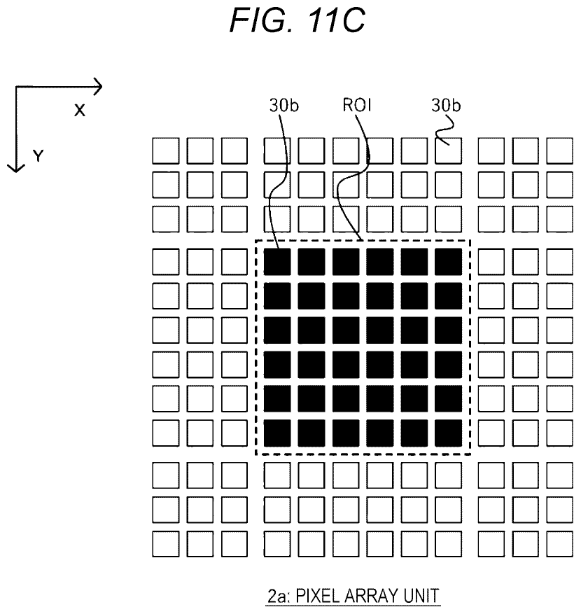

FIGS. 11A to 11C are setting examples of the ROI for the pixel array unit 2a. As described above, the pixel array unit 2a includes the plurality of pixels 30b disposed in the row direction X and the column direction Y. As illustrated in FIG. 11A, the ROI can be set within a range of the entire region in the row direction X and a partial region in the column direction Y in the pixel array unit 2a by the horizontal drive unit 4a and the vertical drive unit 5a. Furthermore, as illustrated in FIG. 11B, the ROI can also be set within a range of a partial region in the row direction X and the entire region in the column direction Y in the pixel array unit 2a. Alternatively, as illustrated in FIG. 11C, the ROI can also be set within a range of a partial region in the row direction X and a partial region in the column direction Y in the pixel array unit 2a.

As described above, in the second embodiment, the ROI can be set in any region in the row direction X and the column direction Y in the pixel array unit 2a by the switching control of the current cutoff switching unit by the horizontal drive unit 4a and the vertical drive unit 5a. In the second embodiment, since only the pixel signal in the ROI set at any pixel position in the pixel array unit 2a is output, power consumption can be reduced by reducing the number of pixel signals output from the pixel array unit 2a, it is not necessary to provide a circuit for ROI setting outside the pixel array unit 2a, and the circuit configuration of the photodetection element can be simplified. Furthermore, an effect can also be obtained that the pixel signal of the ROI can be quickly acquired.

### Third Embodiment

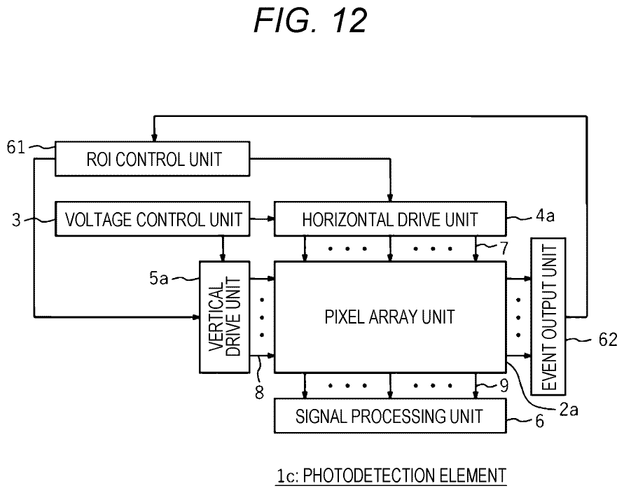

The ROI may be dynamically set, for example, during operation of the photodetection element 1b. For example, in a case where the photodetection element 1b includes an EVS pixel, the ROI may be set in the pixel 30b in which an event is detected or the pixel 30b in the vicinity thereof. FIG. 12 is a block diagram illustrating a configuration example of a photodetection element 1c in a third embodiment. The photodetection element 1c in FIG. 12 includes an event output unit 62 that transmits an event signal to the ROI control unit 61.

In the photodetection element 1c, some pixels 30b of the plurality of pixels 30b in the pixel array unit 2a each output an event signal generated on the basis of an amount of change of the charges accumulated in the corresponding photoelectric conversion element to the event output unit 62. The ROI control unit 61 receives the event signal via the event output unit 62 and performs control of the horizontal drive unit 4a and the vertical drive unit 5a. In accordance with a position of the pixel 30b that has output the event signal, the horizontal drive unit 4a and the vertical drive unit 5a set a location of the ROI by performing switching control of the current cutoff switching unit in the some pixels 30b. Furthermore, the horizontal drive unit 4a and the vertical drive unit 5a perform control to switch the location of the ROI in the pixel array unit 2a such that the ROI before switching and the ROI after switching partially overlap or do not overlap in units of frames.

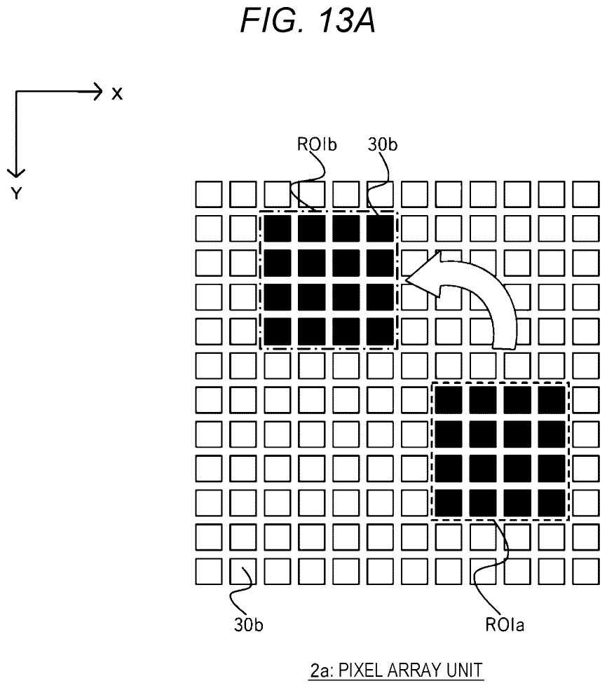

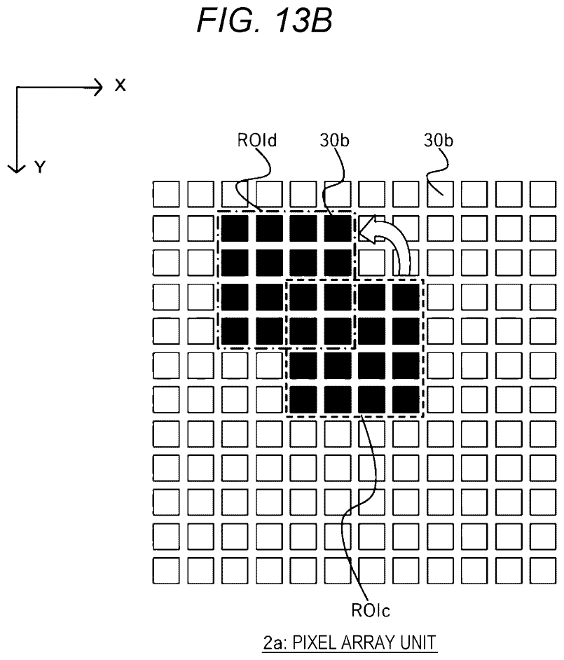

FIGS. 13A and 13B are diagrams illustrating a change in the setting of the ROI in the third embodiment. In FIG. 13A, an example is illustrated in which the ROI is transferred from an ROIa indicated by a broken line to an ROIb indicated by a one-dot chain line. In FIG. 13B, an example is illustrated in which the ROI is transferred from an ROIc indicated by a broken line to an ROId indicated by a one-dot chain line. FIG. 13A illustrates an example in which the ROIa before switching and the ROIb after switching do not overlap. FIG. 13B illustrates an example in which the ROIc before switching and the ROId after switching partially overlap.

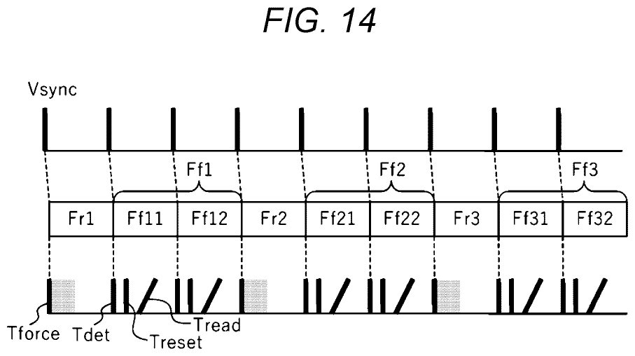

FIG. 14 is a diagram illustrating a switching timing of the ROI of the photodetection element 1c. A vertical synchronization signal Vsync is input to the horizontal drive unit 4a and the vertical drive unit 5a at regular intervals.

Photodetection processing by the photodetection element 1c is performed in units of frames. In FIG. 14, three frame groups Ff1, Ff2, and Ff3 are illustrated. The photodetection processing of a first ROI is performed in the frame group Ff1, the photodetection processing of a second ROI is performed in the frame group Ff2, and the photodetection processing of a third ROI is performed in the frame group Ff3.

There are region switching frames Fr1, Fr2, and Fr3 between the frame groups Ff1, Ff2, and Ff3, and setting of the first ROI is performed in the region switching frame Fr1, switching from the first ROI to the second ROI is performed in the region switching frame Fr2, and switching from the second ROI to the third ROI is performed in the region switching frame Fr3. Each ROI is determined by an event detected by the pixel 30b in the pixel array unit 2a in the immediately preceding ROI. For example, the second ROI is set on the basis of an event detected in the first ROI. Note that a position and size of each ROI may be set in advance.

In each of the frame groups Ff1, Ff2, and Ff3, photodetection processing may be performed in two or more frames in the same ROI. For example, the frame group Ff1 includes frames Ff11 and Ff12.

The frames Fr1, Ff11, Ff12, Fr2, Ff21, Ff22, Fr3, Ff31, and Ff32 illustrated in FIG. 14 are switched by the vertical synchronization signal Vsync.

The region switching frame Fr1 includes a forced reset timing Tforce. In the forced reset timing Tforce, the reset signal XAZ is input to the pixel 30b included in the first ROI. As a result, the charges accumulated in the differentiation circuit 44 of FIG. 6 are reset, and an event can be detected again.

The frame Ff11 includes a detection timing Tdet, a reset timing Treset, and a read timing Tread. The pixel 30b included in the first ROI detects an event at the detection timing Tdet. As a result, for example, the event signal COMP is held in the latch unit 47 of FIG. 6. At the reset timing Treset, the reset signal XAZ is input to the pixel 30b that has detected the event among the pixels 30b included in the first ROI. At the read timing Tread, the event signal COMP is read from the latch unit 47.

Similarly, the frames Ff12, Ff21, Ff22, Ff31, and Ff32 each include the detection timing Tdet, the reset timing Treset, and the read timing Tread, and the region switching frames Fr2 and Fr3 each include the forced reset timing Tforce. That is, in the example in FIG. 14, the forced reset timing Tforce is provided once, the detection timing Tdet, the reset timing Treset, and the read timing Tread are provided twice for each of the first to third ROIs.

In FIG. 12, the example has been described in which the ROI is set around the pixel in which the event is detected, but the ROI may be set around a pixel in which a characteristic image is captured. For example, a face or skin color of a human may be detected, and the ROI may be set around a pixel in which the face or skin color is detected.

As described above, by the switching control of the current cutoff switching unit by the horizontal drive unit 4a and the vertical drive unit 5a, it is possible to dynamically switch the ROI even during operation of the photodetection element 1c. Furthermore, an ROI to be switched next can be set on the basis of a position of the pixel 30b in which an event is detected during operation of the photodetection element. Since there is a high possibility that an event can be detected in the vicinity of the pixel 30b where an event has been detected most recently, the photodetection element 1c in the third embodiment can efficiently set the ROI.

### Fourth Embodiment

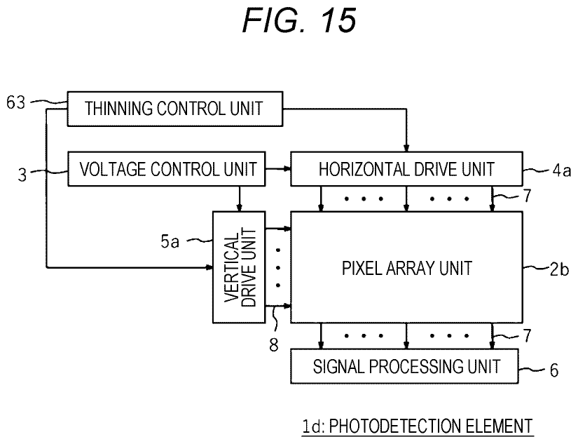

In the second to third embodiments, it has been described that it is possible to reduce the power consumption of the photodetection elements 1b and 1c by setting the ROI, but it is also possible to reduce the power consumption by thinning out some pixels among the plurality of pixels 30b. FIG. 15 is a block diagram illustrating a configuration example of a photodetection element 1d in a fourth embodiment. The photodetection element 1d in FIG. 15 includes a thinning control unit 63 that performs control of the horizontal drive unit 4a and the vertical drive unit 5a.

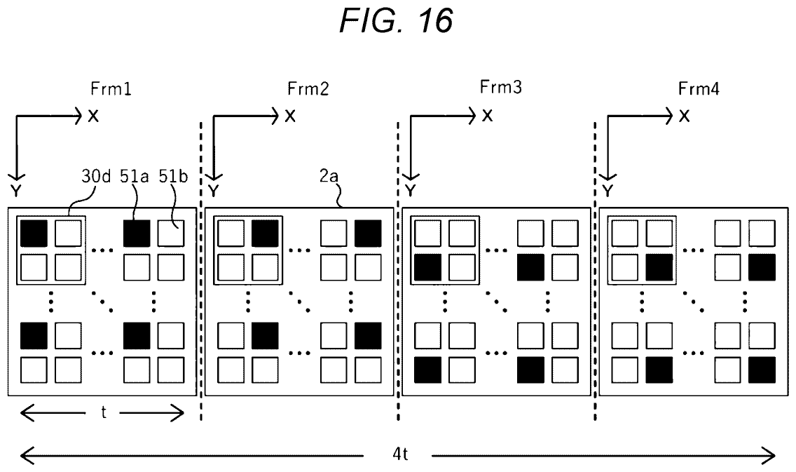

FIG. 16 is a diagram illustrating an example of thinning control. A plurality of pixels 30d in the pixel array unit 2a in the photodetection element 1d includes a plurality of subpixels. Each subpixel of FIG. 16 may be an EVS pixel or a grayscale pixel, but in the following, an example will be described in which each subpixel is the EVS pixel. Each of the plurality of subpixels has a configuration similar to that of the pixel 30b of FIG. 6. Specifically, each of the subpixels includes the photoelectric conversion element 21b, the pixel circuit 22c similar to that of FIG. 7B, at least one current path, and at least two current cutoff switching units. The subpixel includes an effective subpixel 51a and an ineffective subpixel 51b. In the example in FIG. 16, the pixel 30d includes one effective subpixel 51a and three ineffective subpixels 51b.

The horizontal drive unit 4a and the vertical drive unit 5a in the photodetection element 1d are controlled by the thinning control unit 63 to switch the current cutoff switching unit included in each of the plurality of subpixels. As a result, the plurality of subpixels sequentially outputs pixel signals for each frame. In the example in FIG. 16, the effective subpixel 51a and the ineffective subpixel 51b of the pixel 30d are sequentially switched in the order of a frame Frm1, a frame Frm2, a frame Frm3, and a frame Frm4. For each frame, the effective subpixel 51a set in the pixel 30d outputs the pixel signal. Among the four subpixels in each pixel, one is an effective subpixel and remaining three are ineffective subpixels, so that effective subpixels of each pixel are sequentially switched for each frame.

The frames Frm1, Frm2, Frm3, and Frm4 are switched every unit time t. In the example in FIG. 16, the pixel signals are output once from all the subpixels disposed in the pixel 30d in a time of 4t.

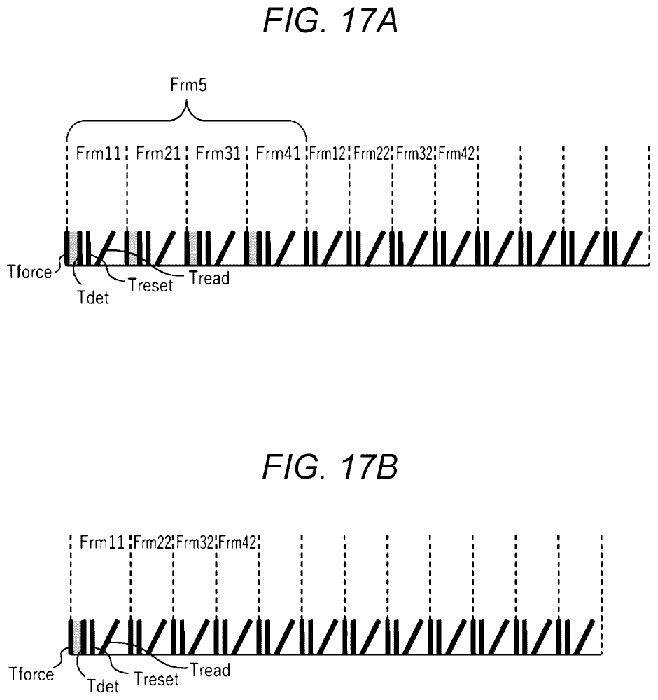

FIG. 17A is a timing diagram illustrating a first example of thinning operation of the photodetection element 1d, and FIG. 17B is a timing diagram illustrating a second example of the thinning operation. Similarly to the example in FIG. 14, switching of the frames is performed by the synchronization signal Vsync input to the horizontal drive unit 4a and the vertical drive unit 5a.

In the first example illustrated in FIG. 17A, in the four frames Frm11 to Frm41 in the beginning, first, forced reset of all the pixels is performed. As a result, the charges accumulated in the pixel circuits of all the subpixels in each pixel are reset. In the four frames Frm11 to Frm41 in the beginning, event detection is performed while sequentially switching one effective subpixel among the four subpixels of each pixel. Specifically, exposure is started after the forced reset of all the pixels, and an event is detected (time Tdet). Thereafter, the subpixel in which the event is detected is reset (time Treset), and thereafter, the effective subpixel is read (time Tread). In and after the fifth frame Frm12 from the beginning, the event detection is performed without performing the forced reset of all the pixels.

In the second example illustrated in FIG. 17B, the forced reset of all the pixels is performed only in the first frame Frm11. After the second frame Frm21, the event detection is performed without performing the forced reset of all the pixels.

As described above, in the fourth embodiment, by sequentially driving one subpixel out of four subpixels in a pixel, it is possible to drive all the subpixels once in four frames. By performing such thinning toggle drive, it is possible to reduce power consumption while uniformly driving all the subpixels.

### Fifth Embodiment

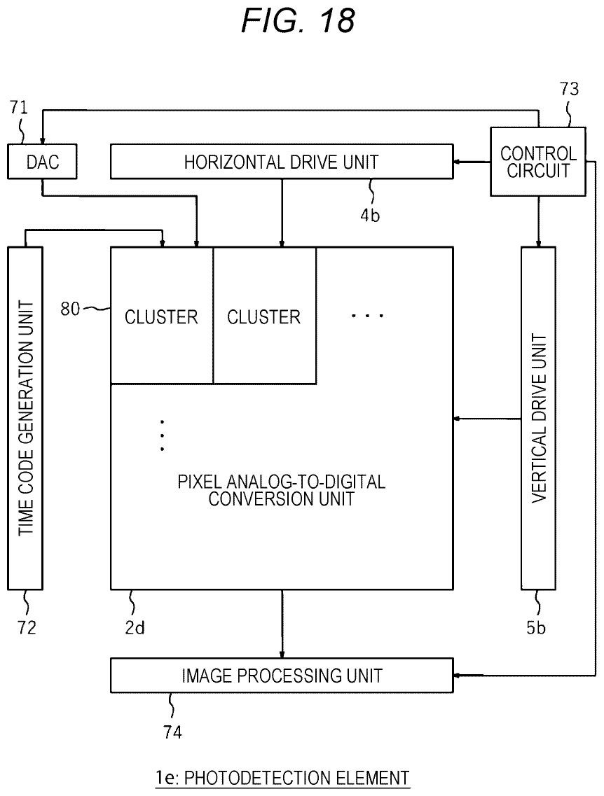

In the first embodiment, the example has been described in which the current cutoff switching unit is provided on the current path in the EVS, but a configuration is also conceivable in which the current cutoff switching unit is provided on a current path of a pixel circuit having an analog-to-digital conversion unit. FIG. 18 is a block diagram illustrating a configuration example of a photodetection element 1e in a fifth embodiment. In the photodetection element 1e of FIG. 18, a digital-to-analog conversion unit (DAC: Digital to Analog Converter) 71, a time code generation unit 72, a pixel analog-to-digital conversion unit 2d, a horizontal drive unit 4b, a vertical drive unit 5b, and a control circuit 73 are disposed.

The digital-to-analog conversion unit 71 generates a reference signal by digital-to-analog (DA) conversion over a predetermined AD conversion period. The time code generation unit 72 generates a time code indicating a time in the AD conversion period. The time code generation unit 72, and the pixel analog-to-digital conversion unit 2d perform AD conversion for converting an analog signal (pixel signal) of each photoelectric conversion unit into a digital signal. The pixel analog-to-digital conversion unit 2d is divided by a plurality of clusters 80. The cluster 80 is provided for each pixel block (not illustrated), and converts an analog signal in the corresponding pixel block into a digital signal. The pixel block includes a plurality of photoelectric conversion units. The cluster 80 includes an analog-to-digital conversion unit connected to the photoelectric conversion unit. The photoelectric conversion unit and the analog-to-digital conversion unit constitute one pixel circuit. A configuration of the pixel circuit will be described later.

The pixel analog-to-digital conversion unit 2d performs AD conversion on the pixel signal to generate image data, and supplies the image data to an image processing unit 74. The horizontal drive unit 4b drives the clusters 80 for one column arranged in a direction in which the horizontal drive line 7 extends in the pixel analog-to-digital conversion unit 2d to execute AD conversion. The vertical drive unit 5b drives the clusters 80 for one row arranged in a direction in which the vertical drive line 8 extends in the pixel analog-to-digital conversion unit 2d to execute AD conversion.

The control circuit 73 controls operation timings of the digital-to-analog conversion unit 71, the horizontal drive unit 4b, the vertical drive unit 5b, and the image processing unit 74 in synchronization with the vertical synchronization signal Vsync.

The image processing unit 74 performs predetermined signal processing and image processing on the image data.

The photodetection element 1e in FIG. 18 can be configured by a stacked structure of the pixel chip 11 and the circuit chip 12, as in FIG. 2. For example, the digital-to-analog conversion unit 71, the time code generation unit 72, the horizontal drive unit 4b, the vertical drive unit 5b, the control circuit 73, and a part of the analog-to-digital conversion unit in the pixel analog-to-digital conversion unit 2d can be disposed on the circuit chip 12. Furthermore, the photoelectric conversion unit and a part of the analog-to-digital conversion unit in the pixel analog-to-digital conversion unit 2d can be disposed on the pixel chip 11.

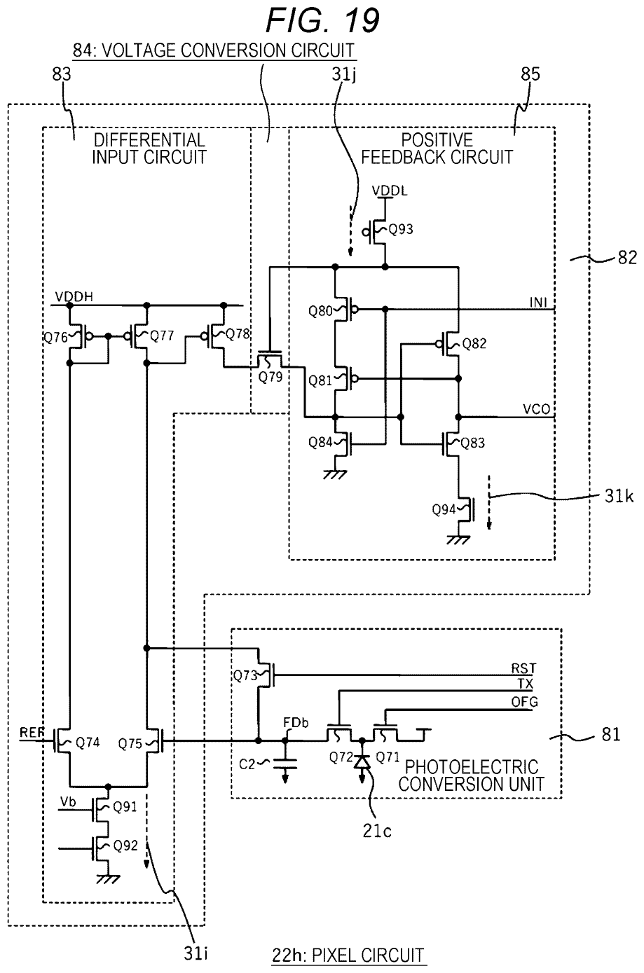

FIG. 19 is a block diagram illustrating a configuration example of a pixel circuit 22h in the fifth embodiment. The pixel circuit 22h includes a photoelectric conversion unit 81 and an analog-to-digital conversion unit 82. The analog-to-digital conversion unit 82 converts a voltage signal according to charges accumulated in a photoelectric conversion element 21c into a digital signal, and includes a differential input circuit 83, a voltage conversion circuit 84, and a positive feedback circuit 85. Furthermore, the analog-to-digital conversion unit 82 includes at least one current path and at least two current cutoff switching units.

The photoelectric conversion unit 81 includes the photoelectric conversion element 21c, a discharge transistor Q71, a transfer transistor Q72, a floating diffusion FDb, a capacitor C2, and a reset transistor Q73. As the reset transistor Q73, the transfer transistor Q72, and the discharge transistor Q71, for example, NMOS transistors are used.

The photoelectric conversion element 21c generates charges by photoelectric conversion. For example, the cathode of the photoelectric conversion element 21c is connected to the source of the discharge transistor Q71 and the drain of the transfer transistor Q72.

The discharge transistor Q71 discharges the charges accumulated in the photoelectric conversion element 21c at the start of exposure in accordance with a drive signal OFG input to the gate. The drive signal OFG is supplied to the gate of the discharge transistor Q71.

The transfer transistor Q72 transfers the charges from the photoelectric conversion element 21c to the floating diffusion FDb at the end of exposure in accordance with a transfer signal TX from the photoelectric conversion unit 81. The drain of the transfer transistor Q72 is connected to the capacitor C2, the source of the reset transistor Q73, and the differential input circuit 83 via the floating diffusion FDb. The transfer signal TX is supplied to the gate of the transfer transistor Q72.

The floating diffusion FDb accumulates the transferred charges and generates a potential according to an amount of accumulated charges.

The capacitor C2 is disposed to be connected to the floating diffusion FDb. The capacitor C2 holds the potential generated by the floating diffusion FDb.

In accordance with the reset signal RST from the photoelectric conversion unit 81, the reset transistor Q73 shifts to the on state and initializes the potential of the floating diffusion FDb. The reset signal RST is supplied to the gate of the reset transistor Q73. The source of the reset transistor Q73 is connected to the differential input circuit 83.

The differential input circuit 83 includes transistors Q74, Q75, Q76, Q77, Q78, Q91, and Q92. As the transistors Q74, Q75, Q91, and Q92, for example, NMOS transistors are used. As the transistors Q76, Q77, and Q78, for example, PMOS transistors are used. Furthermore, the differential input circuit 83 includes a current path 31i. The transistors Q91 and Q92 constitute current cutoff switching units in the current path 31i.

The transistors Q74 and Q75 constitute a differential pair, and the sources of the transistors Q74 and Q75 are commonly connected to the drain of the transistor Q91. Furthermore, the drain of the transistor Q74 is connected to the drain of the transistor Q76 and the gates of the transistors Q76 and Q77. The drain of the transistor Q75 is connected to the drain of the transistor Q77, the gate of the transistor Q78, and the drain of the reset transistor Q73. Furthermore, a reference signal REF from the digital-to-analog conversion unit 71 is input to the gate of the transistor Q74. The gate of the transistor Q75 is connected to the source of the reset transistor Q73 and the floating diffusion FDb.

The transistor Q91 performs switching of whether or not to cut off the current path 31i and switching of a bias current flowing through the current path 31i. Specifically, a bias voltage Vb is applied from the vertical drive unit 5b to the gate of the transistor Q91, and the source of the transistor Q91 is connected to the reference voltage node via the transistor Q92. The transistor Q91 switches whether or not to cut off the current path 31i according to a signal level of the bias voltage Vb, and controls the bias current flowing through the current path 31i.

The transistor Q92 performs switching of whether or not to cut off the current path 31i. Specifically, the drain of the transistor Q92 is connected to the transistor Q91, and the source is connected to the reference voltage node. When a signal at the low level is input from the horizontal drive unit 4b to the gate, the transistor Q92 cuts off the current path 31i. When either the transistor Q91 or Q92 is turned off, the current path 31i is cut off, and drive of the differential input circuit 83 is stopped.

The transistors Q76, Q77, and Q78 constitute a current mirror circuit. A power supply voltage VDDH is applied to the sources of the transistors Q76, Q77, and Q78. The power supply voltage VDDH is higher than a power supply voltage VDDL. Furthermore, the drain of the transistor Q78 is connected to the voltage conversion circuit 84.

The voltage conversion circuit 84 includes a transistor Q79. As the transistor Q97, for example, an NMOS transistor is used. The power supply voltage VDDL is applied to the gate of the transistor Q79. The drain of the transistor Q79 is connected to the drain of the transistor Q78, and the source is connected to the positive feedback circuit 85.

The positive feedback circuit 85 includes transistors Q80, Q81, Q82, Q83, Q84, Q93, and Q94. Furthermore, the positive feedback circuit 85 includes current paths 31j and 31k. As the transistors Q80, Q81, Q82, and Q93, for example, PMOS transistors are used. As the transistors Q83, Q84, and Q94, for example, NMOS transistors are used. The transistor Q93 constitutes a current cutoff switching unit in the current path 31j. The transistor Q94 constitutes a current cutoff switching unit in the current path 31k.

The transistors Q80, Q81, and Q84 are connected in series to the power supply voltage VDDL via the transistor Q93. The source of the transistor Q84 is connected to a reference potential (ground) node, and the drain of the transistor Q84 is connected to the source of the transistor Q81. The source of the transistor Q80 is connected to the drain of the transistor Q81. A drive signal INI from the vertical drive unit 5b is input to the gates of the transistors Q80 and Q84. Furthermore, a connection node of the transistors Q81 and Q84 is connected to the voltage conversion circuit 84.

The transistors Q82 and Q83 are connected in series to the power supply voltage VDDL via the transistor Q93 and connected in series to the reference voltage node via the transistor Q94. The drain of the transistor Q83 is connected to the drain of the transistor Q82. The gates of the transistors Q82 and Q83 are connected to a connection node of the transistors Q81 and Q84. Furthermore, an output signal VCO is output from a connection node of the transistors Q82 and Q83 to a data storage unit (not illustrated) and the like.

The transistor Q93 performs switching of whether or not to cut off the current path 31j. Specifically, the source of the transistor Q93 is connected to the power supply voltage VDDL. The drain of the transistor Q93 is connected to the drain of the transistor Q80, the drain of the transistor Q82, and the gate of the transistor Q79. When a signal at the high level is input from the vertical drive unit 5b to the gate, the transistor Q93 cuts off the current path 31j. At this time, supply of the power supply voltage VDDL to the transistors Q80 and Q82 and the transistor Q79 is stopped.

The transistor Q94 performs switching of whether or not to cut off the current path 31k. Specifically, the source of the transistor Q94 is connected to the reference voltage node, and the drain of the transistor Q94 is connected to the transistor Q83. When a signal at the low level is input from the horizontal drive unit 4b to the gate, the transistor Q94 cuts off the current path 31k. When either the transistor Q93 or the transistor Q94 is turned off, the output signal VCO is not output from the positive feedback circuit 85.

Note that the photoelectric conversion unit 81, the differential input circuit 83, the voltage conversion circuit 84, and the positive feedback circuit 85 are not limited to the circuits exemplified in FIG. 19 as long as they have equivalent functions. Furthermore, the floating diffusion FDb is disposed for each pixel circuit 22h, but it is also possible to share one floating diffusion FDb by a plurality of pixel circuits 22h.

In the example in FIG. 19, the differential input circuit 83 is provided with one current path 31i including two current cutoff switching units. Furthermore, the positive feedback circuit 85 is provided with two current paths 31j and 31k each including one current cutoff switching unit. As a result, it is possible to switch on and off of the differential input circuit 83 and on and off of the positive feedback circuit 85 from the vertical drive unit 5b and the horizontal drive unit 4b. Arrangement of the current cutoff switching unit and the current path is not limited to this example.

As described above, in the fifth embodiment, the pixel circuit 22h including the analog-to-digital conversion unit 82 is provided with at least one current path and at least two current cutoff switching units that switch whether or not to cut off the current path. As a result, also in the pixel circuit 22h, both horizontal drive and vertical drive are achieved.

### (Application Example)

The technology according to the present disclosure can be applied to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, a robot, a construction machine, or an agricultural machine (tractor).

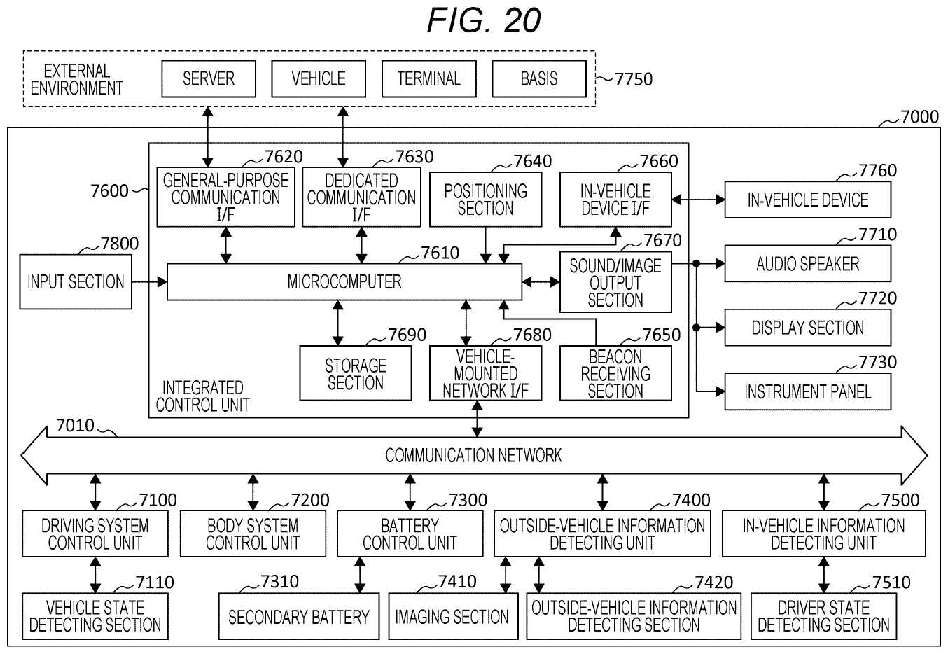

FIG. 20 is a block diagram illustrating an example of schematic configuration of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 20, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 20, as a functional configuration of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are depicted. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

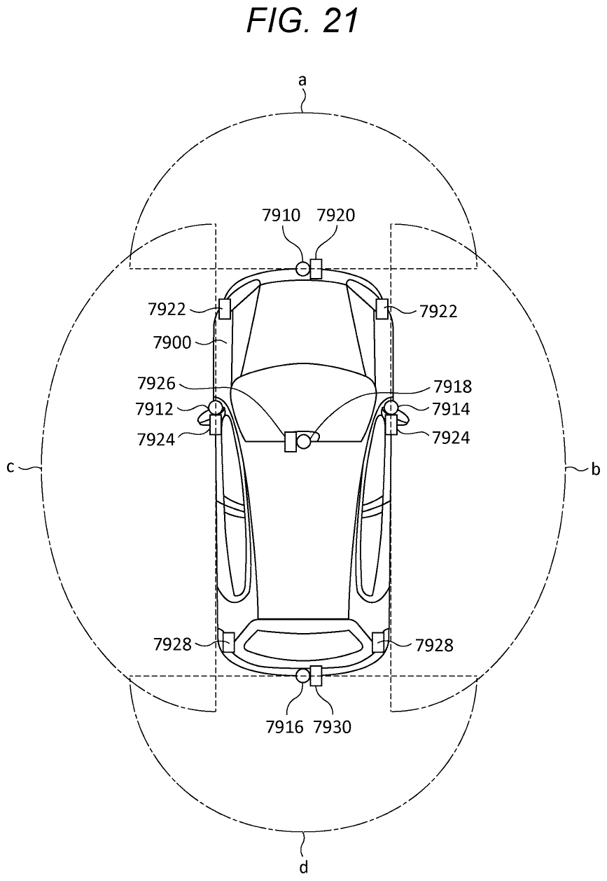

Here, FIG. 21 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 21 illustrates an example of the imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 20, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example in FIG. 20, an audio speaker 7710, a display section 7720, and an instrument panel 7730 are exemplified as output devices. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that at least two control units connected to each other via the communication network 7010 in the example illustrated in FIG. 20 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that the vehicle control system 7000 in FIG. 20 can be configured by the electronic device of the present disclosure. For example, the photodetection element 1a of the present disclosure can be mounted on the imaging section 7410. In this case, the outside-vehicle information detecting unit 7400 is used as a processing unit that performs processing on the image data output from the photodetection element 1a.

Furthermore, a computer program for achieving the horizontal drive unit 4a and the vertical drive unit 5a illustrated in FIG. 1 or the horizontal drive unit 4b and the vertical drive unit 5b illustrated in FIG. 18 can be implemented on any control unit or the like. Furthermore, a computer-readable recording medium in which such a computer program is stored can be provided. The recording medium is, for example, a magnetic disk, an optical disk, a magneto-optical disk, a flash memory, or the like. Furthermore, the computer program described above may be distributed via, for example, a network without using the recording medium.

The horizontal drive unit 4a and the vertical drive unit 5a illustrated in FIG. 1 or the horizontal drive unit 4b and the vertical drive unit 5b illustrated in FIG. 18 may be achieved in a module (for example, an integrated circuit module including one die) for the integrated control unit 7600 illustrated in FIG. 20. Alternatively, the drive units may be achieved by a plurality of control units of the vehicle control system 7000 illustrated in FIG. 20.

Note that the present technology can have the following configurations.

(1) A photodetection element including:
a photoelectric conversion element that accumulates charges according to an amount of incident light; and
a pixel circuit that outputs a pixel signal according to the charges accumulated in the photoelectric conversion element, in which
the pixel circuit includes:
at least one current path; and
at least two current cutoff switching units that switch whether or not to cut off the current path.

(2) The photodetection element according to (1), in which
the pixel circuit includes a first current path, a second current path, a first current cutoff switching unit, and a second current cutoff switching unit,
the first current cutoff switching unit switches whether or not to cut off the first current path, and
the second current cutoff switching unit switches whether or not to cut off the second current path.

(3) The photodetection element according to (1), in which
the pixel circuit includes a first current cutoff switching unit and a second current cutoff switching unit disposed on one current path, and
the first current cutoff switching unit and the second current cutoff switching unit switch whether or not to cut off the current path independently of each other.

(4) The photodetection element according to any one of (1) to (3), further including:
a first control unit that performs control to switch two or more of the current cutoff switching units in two or more of the pixel circuits arranged in a first direction at an identical timing; and
a second control unit that performs control to switch at an identical timing two or more of the current cutoff switching units in two or more of the pixel circuits arranged in a second direction.

(5) The photodetection element according to (4), further including
a pixel array unit including a plurality of pixels arranged in the first direction and the second direction, in which
each of the plurality of pixels includes the photoelectric conversion element and the pixel circuit, and
the first control unit and the second control unit perform control to output, from the pixel array unit, a pixel signal in a focused pixel region including one or more pixels disposed at any location in the pixel array unit by performing switching control of the current cutoff switching units included in each of the plurality of pixels.

(6) The photodetection element according to (5), in which
the first control unit and the second control unit perform control to switch a location of the focused pixel region in the pixel array unit in units of frames such that a part of the focused pixel region overlaps or does not overlap, by performing switching control of the current cutoff switching units included in each of the plurality of pixels.

(7) The photodetection element according to (6), in which
some pixels of the plurality of pixels each output an event signal generated on the basis of an amount of change of the charges accumulated in the photoelectric conversion element corresponding to each pixel, and
the first control unit and the second control unit set the location of the focused pixel region by performing switching control of the current cutoff switching units in the some pixels in accordance with a pixel position at which the event signal is output.

(8) The photodetection element according to (7), in which
the first control unit and the second control unit perform switching control of the current cutoff switching units in the plurality of pixels such that the focused pixel region is disposed within a range of an entire region in the first direction and a partial region in the second direction in the pixel array unit, within a range of a partial region in the first direction and an entire region in the second direction in the pixel array unit, or within a range of a partial region in the first direction and a partial region in the second direction in the pixel array unit.

(9) The photodetection element according to (4), further including
a pixel array unit including a plurality of pixels arranged in the first direction and the second direction, in which
each of the plurality of pixels includes a plurality of subpixels,
each of the plurality of subpixels includes the photoelectric conversion element, the pixel circuit, the at least one current path, and the at least two current cutoff switching units, and
the plurality of subpixels in the pixels sequentially outputs pixel signals for each of frames, by switching the current cutoff switching units included in each of the plurality of subpixels.

(10) The photodetection element according to (4), further including
a pixel array unit including a plurality of pixels arranged in the first direction and the second direction, in which
each of the plurality of pixels includes a plurality of subpixels,
each of the plurality of subpixels includes the photoelectric conversion element, the pixel circuit, the at least one current path, and the at least two current cutoff switching units, and
at least one subpixel of the plurality of subpixels in the pixels outputs the pixel signal including event information generated on the basis of an amount of change of the charges accumulated in the photoelectric conversion element corresponding to the subpixel, and remaining subpixels each output the pixel signal including grayscale information according to the charges accumulated in the photoelectric conversion element corresponding to each subpixel.

(11) The photodetection element according to any one of (1) to (10), in which
some current cutoff switching units of the at least two current cutoff switching units perform switching of a bias current and switching of whether or not to cut off the current path.

(12) The photodetection element according to any one of (1) to (11), in which
the pixel circuit includes an event detection circuit that detects an event generated on the basis of an amount of change of the charges accumulated in the photoelectric conversion element, and
the event detection circuit includes the at least one current path and the at least two current cutoff switching units.

(13) The photodetection element according to (12), in which
the event detection circuit includes:
a current-voltage conversion unit that converts the charges accumulated in the photoelectric conversion element into a voltage;
a buffer that generates a voltage signal according to an output of the current-voltage conversion unit;
a differentiation circuit that detects an amount of change of the voltage signal;
a comparison circuit that compares the amount of change of the voltage signal with a predetermined threshold; and
an output circuit that outputs an event signal representing the event according to a comparison result by the comparison circuit.

(14) The photodetection element according to (13), in which
at least two of the current-voltage conversion unit, the buffer, the differentiation circuit, the comparison circuit, or the output circuit include the current path and the current cutoff switching units.

(15) The photodetection element according to (13), in which
at least one of the current-voltage conversion unit, the buffer, the differentiation circuit, the comparison circuit, or the output circuit includes two or more of the current cutoff switching units disposed on one of the current paths.

(16) The photodetection element according to (1), in which
the pixel circuit includes an analog-to-digital conversion unit that converts a voltage signal according to the charges accumulated in the photoelectric conversion element into a digital signal, and
the analog-to-digital conversion unit includes the at least one current path and the at least two current cutoff switching units.

(17) The photodetection element according to any one of (1) to (16), in which
the current cutoff switching units each include one transistor that switches whether or not to cut off the current path.

(18) The photodetection element according to any one of (1) to (16), in which
the current cutoff switching units each include one transistor that switches whether or not to cut off the current path, and switches whether or not to supply a bias current to the current path.

(19) An electronic device including:
a photodetection element that outputs image data; and
a processing unit that performs processing on the image data, in which
the photodetection element includes:
a photoelectric conversion element that accumulates charges according to an amount of incident light; and
a pixel circuit that outputs a pixel signal according to the charges accumulated in the photoelectric conversion element, and
the pixel circuit includes:
at least one current path; and
at least two current cutoff switching units that switch whether or not to cut off the current path.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1a, 1b, 1c, 1d, 1e Photodetection element
2a, 2b, 2c Pixel array unit
2d Pixel analog-to-digital conversion unit
3 Voltage control unit
4a, 4b Horizontal drive unit
5a, 5b Vertical drive unit
6 Signal processing unit
7 Horizontal drive line
8 Vertical drive line
9 Vertical signal line
11 Pixel chip
12 Circuit chip
13 Light receiving unit
21a, 21b, 21c Photoelectric conversion element
22a, 22b, 22c, 22d, 22e, 22f, 22g, 22h Pixel circuit
30a, 30b, 30c, 30d Pixel
31a, 31b, 31c, 31d, 31e, 31f, 31i, 31j, 31k Current path
31g First current path
31h Second current path
32a, 32b, 32c Circuit unit
33 AND circuit
40 Event detection circuit
41 Current-voltage conversion unit
42 Logarithmic response unit
43 Buffer
44 Differentiation circuit
45 Comparison circuit
46 Output circuit
47 Latch unit
50a EVS pixel
50b Grayscale pixel
51a Effective subpixel
51b Ineffective subpixel
61 ROI control unit
62 Event output unit
63 Control unit
71 Digital-to-analog conversion unit
72 Time code generation unit
73 Control circuit
74 Image processing unit
80 Cluster
81 Photoelectric conversion unit
82 Analog-to-digital conversion unit
83 Differential input circuit
84 Voltage conversion circuit
85 Positive feedback circuit

1. A photodetection element comprising:
a photoelectric conversion element that accumulates charges according to an amount of incident light; and
a pixel circuit that outputs a pixel signal according to the charges accumulated in the photoelectric conversion element, wherein
the pixel circuit includes:
at least one current path; and
at least two current cutoff switching units that switch whether or not to cut off the current path.

2. The photodetection element according to claim 1, wherein
the pixel circuit includes a first current path, a second current path, a first current cutoff switching unit, and a second current cutoff switching unit,
the first current cutoff switching unit switches whether or not to cut off the first current path, and
the second current cutoff switching unit switches whether or not to cut off the second current path.

3. The photodetection element according to claim 1, wherein
the pixel circuit includes a first current cutoff switching unit and a second current cutoff switching unit disposed on one current path, and
the first current cutoff switching unit and the second current cutoff switching unit switch whether or not to cut off the current path independently of each other.

4. The photodetection element according to claim 1, further comprising:
a first control unit that performs control to switch two or more of the current cutoff switching units in two or more of the pixel circuits arranged in a first direction at an identical timing; and
a second control unit that performs control to switch sequentially two or more of the current cutoff switching units in two or more of the pixel circuits arranged in a second direction.

5. The photodetection element according to claim 4, further comprising
a pixel array unit including a plurality of pixels arranged in the first direction and the second direction, wherein
each of the plurality of pixels includes the photoelectric conversion element and the pixel circuit, and
the first control unit and the second control unit perform control to output, from the pixel array unit, a pixel signal in a focused pixel region including one or more pixels disposed at any location in the pixel array unit by performing switching control of the current cutoff switching units included in each of the plurality of pixels.

6. The photodetection element according to claim 5, wherein
the first control unit and the second control unit perform control to switch a location of the focused pixel region in the pixel array unit in units of frames such that a part of the focused pixel region overlaps or does not overlap, by performing switching control of the current cutoff switching units included in each of the plurality of pixels.

7. The photodetection element according to claim 6, wherein
some pixels of the plurality of pixels each output an event signal generated on a basis of an amount of change of the charges accumulated in the photoelectric conversion element corresponding to each pixel, and
the first control unit and the second control unit set the location of the focused pixel region by performing switching control of the current cutoff switching units in the some pixels in accordance with a pixel position at which the event signal is output.

8. The photodetection element according to claim 7, wherein
the first control unit and the second control unit perform switching control of the current cutoff switching units in the plurality of pixels such that the focused pixel region is disposed within a range of an entire region in the first direction and a partial region in the second direction in the pixel array unit, within a range of a partial region in the first direction and an entire region in the second direction in the pixel array unit, or within a range of a partial region in the first direction and a partial region in the second direction in the pixel array unit.

9. The photodetection element according to claim 4, further comprising
a pixel array unit including a plurality of pixels arranged in the first direction and the second direction, wherein
each of the plurality of pixels includes a plurality of subpixels,
each of the plurality of subpixels includes the photoelectric conversion element, the pixel circuit, the at least one current path, and the at least two current cutoff switching units, and
the plurality of subpixels in the pixels sequentially outputs pixel signals for each of frames, by switching the current cutoff switching units included in each of the plurality of subpixels.

10. The photodetection element according to claim 4, further comprising
a pixel array unit including a plurality of pixels arranged in the first direction and the second direction, wherein
each of the plurality of pixels includes a plurality of subpixels,
each of the plurality of subpixels includes the photoelectric conversion element, the pixel circuit, the at least one current path, and the at least two current cutoff switching units, and
at least one subpixel of the plurality of subpixels in the pixels outputs the pixel signal including event information generated on a basis of an amount of change of the charges accumulated in the photoelectric conversion element corresponding to the subpixel, and remaining subpixels each output the pixel signal including grayscale information according to the charges accumulated in the photoelectric conversion element corresponding to each subpixel.

11. The photodetection element according to claim 1, wherein
some current cutoff switching units of the at least two current cutoff switching units perform control of a bias current and switching of whether or not to cut off the current path.

12. The photodetection element according to claim 1, wherein
the pixel circuit includes an event detection circuit that detects an event generated on a basis of an amount of change of the charges accumulated in the photoelectric conversion element, and
the event detection circuit includes the at least one current path and the at least two current cutoff switching units.

13. The photodetection element according to claim 12, wherein
the event detection circuit includes:
a current-voltage conversion unit that converts the charges accumulated in the photoelectric conversion element into a voltage;
a buffer that generates a voltage signal according to an output of the current-voltage conversion unit;
a differentiation circuit that detects an amount of change of the voltage signal;
a comparison circuit that compares the amount of change of the voltage signal with a predetermined threshold; and
an output circuit that outputs an event signal representing the event according to a comparison result by the comparison circuit.

14. The photodetection element according to claim 13, wherein
at least two of the current-voltage conversion unit, the buffer, the differentiation circuit, the comparison circuit, or the output circuit include the current path and the current cutoff switching units.

15. The photodetection element according to claim 13, wherein
at least one of the current-voltage conversion unit, the buffer, the differentiation circuit, the comparison circuit, or the output circuit includes two or more of the current cutoff switching units disposed on one of the current paths.

16. The photodetection element according to claim 1, wherein
the pixel circuit includes an analog-to-digital conversion unit that converts a voltage signal according to the charges accumulated in the photoelectric conversion element into a digital signal, and
the analog-to-digital conversion unit includes the at least one current path and the at least two current cutoff switching units.

17. The photodetection element according to claim 1, wherein
the current cutoff switching units each include one transistor that switches whether or not to cut off the current path.

18. The photodetection element according to claim 1, wherein
the current cutoff switching units each include one transistor that switches whether or not to cut off the current path, and switches whether or not to supply a bias current to the current path.

19. An electronic device comprising:
a photodetection element that outputs image data; and
a processing unit that performs processing on the image data, wherein
the photodetection element includes:
a photoelectric conversion element that accumulates charges according to an amount of incident light; and
a pixel circuit that outputs a pixel signal according to the charges accumulated in the photoelectric conversion element, and
the pixel circuit includes:
at least one current path; and
at least two current cutoff switching units that switch whether or not to cut off the current path.
